(19) United States
(12) Patent Application Publication
(10) Pub. No.: US 2014/0279346 A1
(43) Pub. Date: Sep. 18, 2014

(54) SYSTEMS AND METHODS FOR MODIFYING RELATED GROUPS OF OFFERINGS AND/OR ASPECTS OF OFFERINGS

(71) Applicant: N. Caleb Avery, Brooklyn, NY (US)

(72) Inventor: N. Caleb Avery, Brooklyn, NY (US)

(21) Appl. No.: 13/839,707

(22) Filed: Mar. 15, 2013

Related U.S. Application Data
(63) Continuation of application No. 13/839,380, filed on Mar. 15, 2013.

(51) Int. Cl. G06Q 40/04

(52) U.S. Cl. CPC G06Q 40/04
USPC 705/37

(57) ABSTRACT

The invention generally relates to systems, methods and/or programmed products that can be used for configuring and/or modifying offerings as well as aspects of offerings using participated and/or accepted offer units, related groups of offer units, variables associated with groups of offer units, pricing scales, premiums, discounts, and/or discounts based on aggregated accepted volume, to name a few. The configurable and/or modifiable offerings can include one or more groups of offerings comprising a plurality of offer units. When all of the offer units are participated and/or accepted, then participated and/or accepted offer units at a lower price point and/or having a less desirable variable can be replaced by other accepted for requests to participate having a higher price point and/or more desirable variable.

### CROSS-REFERENCE TO RELATED APPLICATIONS

This application claims priority to U.S. patent application Ser. No. 13/839,380, filed Mar. 15, 2013, the content of which is incorporated herein by reference in its entirety.

### FIELD

The present invention relates to systems and methods for configuring and modifying offerings and/or aspects of offerings.

### SUMMARY

In exemplary embodiments, methods for configuring and modifying offerings and/or aspects of offerings can include configuring, using one or more computers, a debt offering, the debt offering including one or more groups of offer units including one or more offer units, the offer units can be at one or more price points that can be available for one or more participation requests. The method can further include receiving, at the one or more computers from one or more potential purchaser computers, the one or more participation requests to participate in at least some of the one or more groups of offer units of the debt offering at the one or more price points and/or determining, using the one or more computers, to at least one of accept or reject the one or more participation requests in one or more groups of offer units of the a debt offering based on the availability of one or more requested offer units, each of one or more accepted offer units that can be affiliated with one or more offer unit parameters.

In exemplary embodiments, messages can be communicated, from the one or more computers to the one or more potential purchaser computers, of at least the one or more accepted offer units to accepted potential purchasers and non-accepted potential purchasers and/or an analysis, using the one or more computers, can be performed within the one or more groups of offer units at least one of groups of: (i) the one or more offer unit parameters, (ii) statistics related to groups of one or more offer unit parameters of the one or more accepted offer units, or (iii) statistics related to groups of one or more offer unit parameters of one or more non-accepted offer units. Further, in exemplary embodiments, the method can modify, using the one or more computers, the debt offering in response to the analysis so that at least one of (i) one or more groups of offer units that can be split from the one or more groups of offer units forming an additional one or more groups of offer units, or (ii) one or more groups of offer units that can be reconfigured so that the offer units at each of one or more price points within the one or more groups of offer units that can be adjusted. In exemplary embodiments, the method can further include re-offering, from the one or more computers to the one or more potential purchaser computers, the modified debt offering to all potential purchasers.

In exemplary embodiments, methods for configuring and modifying offerings and/or aspects of offerings can include configuring, using one or more computers, a debt offering, the debt offering including a first one or more groups of offer units and a second one or more groups of offer units, the first and second one or more groups of offer units can include one or more offer units, the offer units can be at one or more price points that can be available for one or more participation requests.

In exemplary embodiments, methods for configuring and modifying offerings and/or aspects of offerings can include receiving, at the one or more computers from a one or more potential purchaser computers, the one or more participation requests to participate in at least some of the first one or more groups of offer units and the second one or more groups of offer units of the debt offering at the one or more price points and/or determining, using the one or more computers, to at least one of accept or reject the one or more participation requests in at least some of the first one or more groups of offer units and the second one or more groups of offer units of the debt offering based on the availability of one or more requested offer units, each of one or more accepted offer units can be affiliated with one or more offer unit parameters. In exemplary embodiments, messages can be communicated, from the one or more computers to at least the one or more potential purchaser computers, of the one or more accepted offer units to accepted potential purchasers and non-accepted potential purchasers.

Further, in exemplary embodiments an analysis can be performed, using the one or more computers, analyzing within the first one or more groups of offer units and the second one or more groups of offer units at least one of groups of: (i) the one or more offer unit parameters, (ii) statistics related to groups of one or more offer unit parameters of the one or more accepted offer units, or (iii) statistics related to groups of one or more offer unit parameters of one or more non-accepted offer units. In exemplary embodiments, the method can further include modifying, using the one or more computers, the debt offering in response to the analysis so that the first one or more groups of offer units and the second one or more groups of offer units can be merged and/or re offering, from the one or more computers to the one or more potential purchaser computers, the modified debt offering to all potential purchasers.

In exemplary embodiments, methods for configuring and modifying offerings and/or aspects of offerings can include configuring, using one or more computers, an equity offering, the equity offering including two or more groups of related offer units, including one or more offer units, the offer units can be at one or more price points that can be available for one or more participation requests, the offer units of the two or more groups of related offer units can be related to allow at least one of addition, subtraction, or substitution of each other's offer units. In exemplary embodiments, the methods can include receiving, at the one or more computers from a one or more potential purchaser computers, the one or more participation requests to participate in at least some of the two or more groups of related offer units of the equity offering at the one or more price points and/or determining, using the one or more computers, to at least one of accept or reject the one or more participation requests in the two or more groups of related offer units of the equity offering based on the availability of one or more requested offer units, each of one or more accepted offer units can be affiliated with one or more offer unit parameters.

In exemplary embodiments, messages can be communicated, from the one or more computers to the one or more potential purchaser computers, of at least the one or more accepted offer units to accepted potential purchasers and non-accepted potential purchasers. In exemplary embodiments an analysis can performed, using the one or more computers, that analyzes within the two or more groups of related offer units at least one of one or more groups of: (i) the one or more offer unit parameters, (ii) statistics related to groups of one or more offer unit parameters of the one or more accepted offer units, or (iii) statistics related to groups of one or more offer unit parameters of one or more non-accepted offer units.

In exemplary embodiments, the methods can further include modifying, using the one or more computers, at least one of manually or automatically using a set of rules, the equity offering in response to the analysis so that at least one of: (i) the one or more price points of the two or more groups of related offer units can be changed; (ii) allocation within at least one of the two or more groups of related offer units can be changed; or (iii) the offer units within one of the two or more groups of related offer units may be substituted for the offer units within another of the two or more groups of related offer units. In exemplary embodiments, the methods can further include re-offering, from the one or more computers to the one or more potential purchaser computers, the modified equity offering to all potential purchasers.

In exemplary embodiments, methods for configuring and modifying offerings and/or aspects of offerings can include configuring, using one or more computers, an equity offering, the equity offering including one or more groups of offer units including one or more offer units, the offer units can be at one or more price points and can have one or more conditional pricing options associated with at least one of different optional premium or different optional discount, the offer units can be available for one or more participation requests.

In exemplary embodiments, the method can further include receiving, at the one or more computers from one or more potential purchaser computers, the one or more participation requests to participate in at least some of the one or more groups of offer units of the equity offering at the one or more price points and at the one or more conditional pricing options and/or determining, using the one or more computers, to at least one of accept or reject the one or more participation requests in one or more groups of offer units of the equity offering based on the availability of a one or more requested offer units, each of one or more accepted offer units can be affiliated with one or more offer unit parameters, associated with price and volume, and the one or more conditional pricing options.

In exemplary embodiments messages can be communicated, from the one or more computers to the one or more potential purchaser computers, of at least the one or more accepted offer units to accepted potential purchasers and non-accepted potential purchasers.

In exemplary embodiments, methods for discounting for aggregate accepted volume of offer units, can include: (1) configuring, at one or more computers, an debt offering, the debt offering including a one or more groups of offer units including a one or more offer units, the offer units can be at a one or more price points and can be at an aggregate volume discount, the offer units can be available for a one or more participation requests; (2) communicating, from the one or more computers to one or more potential purchaser computers, a module for monitoring and analyzing (i) the offer units at the one or more price points and (ii) the offer units at the one or more price points with the aggregate volume discount applied; (3) allowing receipt, at the one or more computers from a one or more potential purchaser computers, of the one or more participation requests to participate in one or more groups of offer units of the debt offering at the one or more price points and at the aggregate volume discount applied; (4) determining, at the one or more computers, to accept and/or reject the one or more participation requests in one or more groups of offer units of the debt offering based on the availability of a one or more requested offer units, each of a one or more accepted offer units can be affiliated with a one or more offer unit parameters and the aggregate volume discount applied; and/or (5) communicating, from the one or more computers to the module, (i) the offer units at the current one or more price points; (ii) the offer units at the current one or more price points with the current aggregate volume discount applied; (iii) any changes to the offer units at the current one or more price points; and/or (iv) any changes to the offer units at the current one or more price points with the current aggregate volume discount applied.

In exemplary embodiments, the offer units, when offered for later sale, can include corporate bonds, commercial paper, municipal bonds, international bonds, sovereign debt, sub-sovereign debt, public debt, securitization of assets, notes, or convertible debt securities, debt instruments having the same maturity, debt instruments having the same coupon rate, and/or debt instruments available for reservation by a predetermined investor class.

In exemplary embodiments, the one or more price points can be a yield, a yield rate, an interest rate, a coupon rate, a yield equivalent, a yield-to-maturity rate, a yield-to-call rate, a yield-to-worst-call rate, and/or a spread from an index.

In exemplary embodiments, methods can include the step of setting a threshold yield for participation requests.

In exemplary embodiments, the one or more offer unit parameters can include price and/or volume.

In exemplary embodiments, the number of offer units of a particular offer unit parameter available at a particular price point can be limited to fewer units than the total number of offer units.

In exemplary embodiments, methods can include the step of not accepting a request for reservation that fails to meet a predetermined condition.

In exemplary embodiments, methods for configuring groups of offer units including three variables, can include: (1) configuring, at one or more computers, an contractual right offering, the contractual rights offering including a one or more groups of offer units including a one or more offer units, the offer units can be at a one or more price points and can include a one or more additional variables, and the offer units can be available for a one or more participation requests; (2) allowing receipt, at the one or more computers from a one or more potential purchaser computers, of the one or more participation requests to participate in one or more groups of offer units of the contractual rights offering at the one or more price points and at the one or more additional variables; (3) determining, at the one or more computers, to accept and/or reject the one or more participation requests in one or more groups of offer units of the contractual rights offering based on the availability of a one or more requested offer units, each of a one or more accepted offer units can be affiliated with a one or more offer unit parameters and the one or more additional variables; and/or (4) communicating messages, from the one or more computers to the one or more potential purchaser computers, of the one or more accepted offer units to accepted potential purchasers and non-accepted potential purchasers.

In exemplary embodiments, the one or more price points can be an interest yield and/or a yield equivalent.

In exemplary embodiments, the price can include one or more of the following: a yield rate, an interest rate, a coupon rate, a price equivalent, a yield-to-maturity rate, a yield-to-call rate, a yield-to-worst-call rate, and/or a spread from an index.

In exemplary embodiments, methods may include the step of setting a threshold price for participation requests.

In exemplary embodiments, the number of units of a particular offer unit parameter available at a particular price can be limited to fewer units than the total number of units of the contract rights offering.

In exemplary embodiments, the contractual rights can include revenue streams from one or more contracts.

In exemplary embodiments, the contractual rights can be for goods.

In exemplary embodiments, the goods can be commodities.

In exemplary embodiments, the contract rights can be for services.

In exemplary embodiments, the contractual rights can be used to hedge risk.

In exemplary embodiments, the method used to hedge risk can be insurance.

In exemplary embodiments, the contractual rights can be to real property.

In exemplary embodiments, the contractual rights can be to used property.

In exemplary embodiments, the contractual rights can be to intellectual property.

In exemplary embodiments, the contractual rights can be of a series.

In exemplary embodiments, the contractual rights can have the same maturity.

In exemplary embodiments, the contractual rights can have the same price.

In exemplary embodiments, the contract rights can be available for reservation by a predetermined contract rights purchaser class.

In exemplary embodiments, the predetermined contract rights purchaser class can include one or more institutional contract rights purchasers.

In exemplary embodiments, the predetermined contract rights purchaser class can include one or more retail contract rights purchasers.

In exemplary embodiments, the contract rights for the predetermined contract rights purchaser class can have a predetermined price.

In exemplary embodiments, the number of units of contract rights for the predetermined contract rights purchaser class can be fixed.

In exemplary embodiments, the contract rights for the predetermined contract rights purchaser class can have one or more prices calculated based on the prices of other reservations outside the predetermined contract rights purchaser class.

In exemplary embodiments, the one or more offer unit parameters can include price and/or volume.

In exemplary embodiments, methods can include the step of not accepting a request for reservation that fails to meet a predetermined condition.

In exemplary embodiments, methods for modifying related groups of offer units, can include: (1) configuring, at one or more computers, an equity offering, the equity offering including a two or more groups of related offer units, including a one or more offer units, the offer units can be at a one or more price points that can be available for a one or more participation requests, the offer units of the two or more groups of related offer units can be related to allow addition, subtraction, and/or substitution of each other's offer units; (2) allowing receipt, at the one or more computers from a one or more potential purchaser computers, of the one or more participation requests to participate in the two or more groups of related offer units of the equity offering at the one or more price points; (3) determining, at the one or more computers, to accept and/or reject the one or more participation requests in the two or more groups of related offer units of the equity offering based on the availability of a one or more requested offer units, each of a one or more accepted offer units can be affiliated with a one or more offer unit parameters; (4) communicating messages, from the one or more computers to the one or more potential purchaser computers, of the one or more accepted offer units to accepted potential purchasers and non-accepted potential purchasers; (5) analyzing, at the one or more computers, within the two or more groups of related offer units one or more groups of the one or more offer unit parameters, statistics related to groups of one or more offer unit parameters of the one or more accepted offer units, and/or statistics related to groups of one or more offer unit parameters of a one or more non-accepted offer units; (6) modifying, at the one or more computers, manually and/or automatically using a set of rules, the equity offering in response to the analysis so that (i) the one or more price points of the two or more groups of related offer units can be changed; (ii) allocation within one of the two or more groups of related offer units can be changed; and/or (iii) the offer units within one of the two or more groups of related offer units can be substituted for the offer units within another of the two or more groups of related offer units; and/or (7) re-offering, from the one or more computers to the one or more potential purchaser computers, the modified equity offering to all potential purchasers.

In exemplary embodiments, methods can include: communicating messages of the modification, after modifying the equity offering, to existing accepted potential purchasers and non-accepted potential purchasers.

In exemplary embodiments, the equity offering can generate an order book.

In exemplary embodiments, the analysis can include analysis of pricing momentum, pricing allocation, pricing range, pricing dispersion, allocation dispersion, types of purchaser, balance of the one or more participation requests accepted across multiple groups of the one or more groups of offer units, balance of the one or more participation requests not accepted across multiple groups of the one or more groups of offer units, spreads on multiple of the one or more participation requests accepted of the one or more groups of offer units, spreads on multiple of the one or more participation requests not accepted of the one or more groups of offer units, behavior of potential purchasers in response to the one or more participation requests accepted of other potential purchasers, and/or iterative behavior of the same potential purchaser.

In exemplary embodiments, the one or more offer unit parameters can include price and/or volume.

In exemplary embodiments, methods can include: receiving, from the potential purchaser of the one or more accepted offer units, an accepting of the modified equity offering.

In exemplary embodiments, methods can include the step of not accepting a request for reservation that fails to meet a predetermined condition.

### BRIEF DESCRIPTION OF THE DRAWINGS

The features and advantages of the present invention will be more fully understood with reference to the following, detailed description when taken in conjunction with the accompanying figures, wherein:

FIGS. 1A-1B are block diagrams of certain components of the systems and methods for configuring and modifying offerings and/or aspects of offerings, in accordance with exemplary embodiments of the present invention;

FIGS. 2A-2F illustratively depict various elements of exemplary offerings, in accordance with exemplary embodiments of the present invention;

FIGS. 2G-2I illustratively depict various exemplary communications, in accordance with exemplary embodiments of the present invention;

FIG. 2J illustratively depicts exemplary participation requests, in accordance with exemplary embodiments of the present invention;

FIGS. 3A-3B are a flow chart illustrating offerings being modified by adding to and/or subtracting from the one or more groups of offer units, in accordance with exemplary embodiments of the present invention;

FIGS. 4-5 illustratively depict exemplary offerings being modified by adding to and/or subtracting from the one or more groups of offer units, in accordance with exemplary embodiments of the present invention;

FIG. 6 is a flow chart illustrating offerings being modified by splitting from the one or more groups of offer units at least one groups of offer units to form an additional one or more groups of offer units, in accordance with exemplary embodiments of the present invention;

FIG. 7 illustratively depicts exemplary offerings being modified by splitting from the one or more groups of offer units at least one groups of offer units to form an additional one or more groups of offer units, in accordance with exemplary embodiments of the present invention;

FIG. 8 is a flow chart illustrating offerings being modified by reconfiguring one or more groups of offer units, in accordance with exemplary embodiments of the present invention;

FIG. 9 illustratively depicts exemplary offerings being modified by reconfiguring one or more groups of offer units, in accordance with exemplary embodiments of the present invention;

FIG. 10 is a flow chart illustrating offerings being modified by merging a first one or more groups of offer units with a second one or more groups of offer units, in accordance with exemplary embodiments of the present invention;

FIG. 11 illustratively depicts exemplary offerings being modified by merging a first one or more groups of offer units with a second one or more groups of offer units, in accordance with exemplary embodiments of the present invention;

FIGS. 12A-12B is a flow chart illustrating offerings that can be modified to allow addition, subtraction, and/or substitution of each others offer units, in accordance with exemplary embodiments of the present invention;

FIGS. 13-15 illustratively depict exemplary modifying of aspects of two or more groups of related offer units, in accordance with exemplary embodiments of the present invention;

FIG. 16 is a flow chart illustrating offerings can include one or more groups of offer units that can include at least three variables and/or one or more groups of offer units that can be multidimensional, in accordance with exemplary embodiments of the present invention;

FIG. 17 illustratively depicts exemplary offerings that can be configured to include one or more groups of offer units that can include at any number of variables and/or any number of dimensions (e.g., n dimension), in accordance with exemplary embodiments of the present invention;

FIG. 18 is a flow chart illustrating offerings that can include one or more groups of offer units that can include offer unit parameters, that can be price and volume, and a pricing scale, in accordance with exemplary embodiments of the present invention;

FIG. 19 is a flow chart illustrating one or more pricing scales of offerings can be modified in response to analyzing various exemplary information, in accordance with exemplary embodiments of the present invention;

FIGS. 20A-20B illustratively depicts exemplary one or more pricing scales of offerings that can be modified, in accordance with exemplary embodiments of the present invention;

FIG. 21 is a flow chart illustrating offerings that can include one or more groups of offer units that can include offer unit parameters, that can be price and volume, and a one or more conditional pricing options, in accordance with exemplary embodiments of the present invention;

FIG. 22 illustratively depicts exemplary participation requests that can include one or more conditional pricing options, in accordance with exemplary embodiments of the present invention;

FIG. 23 is a flow chart illustrating offerings that can include one or more groups of offer units that can include offer unit parameters, that can be price and volume, and an at least one aggregate volume discount, in accordance with exemplary embodiments of the present invention; and

FIG. 24 illustratively depicts exemplary participation requests that can include aggregate volume discount, in accordance with exemplary embodiments of the present invention.

### DETAILED DESCRIPTION

The invention generally relates to systems, methods and/or programmed products that can be used for configuring and/or modifying offerings as well as aspects of offerings using participated and/or accepted offer units, related groups of offer units, variables associated with groups of offer units, pricing scales, premiums, discounts, and/or discounts based on aggregated accepted volume, to name a few. The configurable and/or modifiable offerings can include one or more groups of offerings comprising a plurality of offer units. Communicated requests for participation in one or more groups of offer units can be accepted and/or rejected such that the offering can include participated and/or accepted offer units as well as non-participated/non-accepted offer units. When all of the offer units are participated and/or accepted, then participated and/or accepted offer units at a lower price point and/or having a less desirable variable can be replaced by other accepted for requests to participate having a higher price point and/or more desirable variable.

Referring to FIGS. 1A-1B, in exemplary embodiments, an offer system 100, a matching system 102, and/or a potential purchaser system 104 can be used for configuring and/or modifying offerings as well as aspects of offerings using participated and/or accepted offer units, related groups of offer units, variables associated with groups of offer units, pricing scales, premiums, discounts, and/or discounts based on aggregated accepted volume, any combination and/or further separation thereof, and/or can be used for and/or to accomplish any of the aspects disclosed.

In exemplary embodiments, it will be understood that any of offer system 100, matching system 102, and/or potential purchaser system 104 can communicate with each other and/or can be further combined and/or separated. For ease, offer system 100, matching system 102, and/or potential purchaser system 104 are, at times, shown separately. This is merely for ease and is in no way meant to be a limitation.

Further, any element of offer system 100, matching system 102, and/or potential purchaser system 104 can reside on and/or be affiliated with matching system 102, offer system 100, potential purchaser system 104. For example, referring to FIG. 1B, matching system 102 can be an algorithm stored in processor-readable memory that can be accessed and/or processed by a processor affiliated with offer system 100. Further, in exemplary embodiments, algorithms and/or modules affiliated with offer system 100, matching system 102, and/or potential purchaser system 104 can reside on and/or be affiliated with matching system 102, offer system 100, and/or potential purchaser system 104. In exemplary embodiments, algorithms and/or modules can reside in processor readable memory that can be accessed and/or processed by a processor affiliated with offer system 100, matching system 102, and/or potential purchaser system 104.

Referring to FIGS. 1A-1B, as shown, offer system 100, matching system 102, and/or potential purchaser system 104 can include, but are not limited to, at least one communication portal 101, 101′, 101″; at least one graphical user interface 103, 103′, 103″; at least one user input 105, 105′, 105″; at least one speaker 107, 107′, 107″; at least one processor readable memory 109, 109′, 109″; at least one processor 111, 111′, 111″; and any other reasonable components for use in communicating information (e.g., data), storing information, and processing any form of information. In exemplary embodiments, processor readable memory 109, 109′, 109″ can include an at least one non-transitory computer storage medium and/or information (e.g., data) stored in processor readable memory 109, 109′, 109″ can include information (e.g., data) stored in at least one non-transitory computer storage medium.

In some instances, graphical user interface 103, 103′, 103″ and user input 105, 105′, 105″ can be substantially the same. For example, graphical user interface 103, 103′, 103″ and user input 105, 105′, 105″ can be combined as a touch distribution system. The touch distribution system can be a display that can detect the presence and location of a touch within the distribution system area.

In exemplary embodiments, offer system 100, matching system 102, and/or potential purchaser system 104 can be, for example, a mobile phone, computer, server, tablet, smartphone, and any combination and/or further separation thereof, to name a few.

In exemplary embodiments, offer system 100, matching system 102, and/or potential purchaser system 104 can include a plurality of subsystems and/or libraries, such as, but not limited to, one or more offering library subsystems, one or more groups of offer units library subsystem, one or more participation requests library subsystems, one or more offer units library subsystems, one or more participated and/or accepted offer units library subsystems, one or more non-participated/non-accepted offer units library subsystems, one or more price points library subsystems, one or more additional variables library subsystems, at least one variable pricing scale library subsystem, one or more conditional pricing options library subsystems, one or more aggregate volume discount library subsystems, and one or more module library subsystems, to name a few.

In exemplary embodiments, offerings can be modified by, for example, adding one or more additional groups of offer units to the one or more groups of offer units; subtracting from the one or more groups of offer units by deleting one or more groups of offer units; splitting from the one or more groups of offer units at least one group of offer units to form an additional one or more groups of offer units; reconfiguring one or more groups of offer units so that the number of offer units at the price point(s) within one or more groups of offer units can be adjusted; merging a first one or more groups of offer units with a second one or more groups of offer units; and/or any further combination and/or separation thereof, to name a few.

In exemplary embodiments, related groups of offer units can be modified in offerings. For example, offerings can be modified in response to, for example, price point(s) of two or more groups of related offer units that may have changed; allocation within at least one of two or more groups of related offer units that may have changed; offer units within one group of offer units that may have been substituted for offer units within a second group of offer units; and/or any further combination and/or separation thereof, to name a few.

In exemplary embodiments, offerings can be configured to include one or more groups of offer units that can include at least three variables. For example, one or more groups of offer units can include offer units that include offer unit parameters, that can be price and volume, and one or more variables. Further, in exemplary embodiments, participation in one or more groups of offer units of an offering can be based on the availability of the requested offer units, each of the accepted offer units being affiliated with an offer unit parameters, and/or the one or more additional variables.

In exemplary embodiments, offerings can be configured to include one or more groups of offer units that can include offer unit parameters, that can be price and volume, and a one or more pricing scales. Further, in exemplary embodiments, one or more pricing scales of offerings can be modified in response to analyzing within one or more groups of offer units at least one of the one or more groups of offer unit parameters, statistics related to the accepted groups of offer unit parameters, and/or statistics related to non-accepted groups of offer unit parameters.

In exemplary embodiments, offerings can be configured to include one or more groups of offer units that can include offer unit parameters, that can be price and volume, and a one or more conditional pricing options. Further, in exemplary embodiments, participation in one or more groups of offer units of an offering can be based on availability of the requested offer units, each of the accepted offer units being affiliated with one or more offer unit parameters and one or more conditional pricing options parameters.

In exemplary embodiments, offerings can be configured to include one or more groups of offer units that can include offer unit parameters, that can be price and volume, and an aggregate volume discount. Further, in exemplary embodiments, participation in one or more groups of offer units of an offering can be based on availability of the requested offer units, each of the accepted offer units being affiliated with one or more offer unit parameters, and/or the aggregate volume discount applied.

The systems and methods disclosed herein can be used with and/or in conjunction with systems, methods, embodiments, and various disclosures described in U.S. Pat. No. 7,698,211 to N. Caleb Avery (“the '211 patent); U.S. Pat. No. 7,877,314 to N. Caleb Avery (“the '314 patent); U.S. Pat. No. 7,620,590 to N. Caleb Avery (“the '590 patent); U.S. Pat. No. 7,693,779 to N. Caleb Avery (“the '779 patent); U.S. Pat. No. 7,870,057 to N. Caleb Avery (“the '057 patent); U.S. Pat. No. 7,676,423 to N. Caleb Avery (“the '423 patent); U.S. Pat. No. 7,676,423 to N. Caleb Avery (“the '423 patent); U.S. patent application Ser. No. 13/736,824 to N. Caleb Avery (“the ″824 application”); and U.S. patent application Ser. No. 12/973,758 to N. Caleb Avery (“the ″758 application”), the contents of each of which are incorporated herein by reference in their entireties.

In exemplary embodiments, referring to FIG. 2A-2F, in exemplary embodiments, an offering 200 can include one or more groups of offer units 202, and each of one or more groups of offer units 202 can include a plurality of offer units 204. Each offer unit 204 of one or more groups of offer units 202 can be participated in and/or accepted as well as non-participated in and/or non-accepted, for example, such that one or more groups of offer units 202 can include participated and/or accepted offer units 206 as well as non-participated/non-accepted offer units 208.

In exemplary embodiments, offering 100 can be made available to potential purchasers such that, for example, potential purchasers can submit a request, for example, as illustrated in FIG. 2J, to participate in offer units 204 of one or more groups of offer units 202. Depending upon various parameters, variables, and/or other criteria the request to participate in offer units 204 of one or more groups of offer units 202 can be accepted and/or rejected, for example, by the offeror (e.g., issuer, 3rd party, etc.) of the offering 200.

Referring to FIG. 2J, in exemplary embodiments, a participant offer unit request can include one or more price points and/or can be communicated to potential purchaser system 104, for example, from offer system 100 and/or matching system 102. Participant offer unit requests including one or more price points 232 can be presented in a form and/or in graphical user interface 103, 103′, and/or 103′ and/or associated with potential purchaser system 104, offer system 100, and/or matching system 102. In exemplary embodiments, offerings and/or one or more price points 232 can be configured and/or modified to include one or more groups of offer units that can include offer unit parameters, that can be price 236 and/or volume 238.

In exemplary embodiments, one or more participation requests 232 can be communicated to potential purchaser system 104, offer system 100, and/or matching system 102, by a potential purchaser selecting to submit 234 one or more participation requests 232.

Referring to FIG. 2A-2F, in exemplary embodiments, one or more groups of offer units 202 can include an initial targeted group of offer units 210 to be participated in and/or accepted as well as an oversubscription buffer 212 for additional participated and/or accepted offer units. This can create a set number of available offer units 204 available for being participated and/or accepted offer units. In exemplary embodiments, additional participated and/or accepted offer units, for example, in oversubscription buffer 212 can replace earlier participated and/or accepted offer units.

By way of example, referring to FIG. 2A, an offering 200 can be provided that includes one or more groups of offer units 202 which can include a plurality of offer units 204. As shown, offering 200 can include a set number of offer units 210 that can be participated and/or accepted offer units and a buffer offer units 212 that can be for additional participated and/or accepted offer units. Referring to FIG. 2B, in exemplary embodiments, a first set of offer units 214 can be participated in and/or accepted. Referring to FIG. 2C, in exemplary embodiments, a second set of offer units 216 can be participated in and/or accepted. Referring to FIG. 2D, in exemplary embodiments, each of the offer units in one or more groups of offer units 202 can be participated in and/or accepted until, for example, all offer units in initial targeted group of offer units 210 are participated in and/or accepted. Referring to FIG. 2E, in exemplary embodiments, with all offer units in an initial targeted group of offer units 210 participated in and/or accepted, a set of offer units 218 can be participated in and/or accepted in oversubscription buffer 212. Referring to FIG. 2F, in exemplary embodiments, this set of offer units 218 can then replace one or more previously participated and/or accepted offer units 220.

In exemplary embodiments, replacing previously participated and/or accepted offer units 220 with a set of offer units 218 can cause the overall value of offering 200 to increase. Further, in exemplary embodiments, the offer units can be replaced based on when they were participated in and/or accepted. For example, later participated in and/or accepted offer units at a same value as earlier participated in and/or accepted offer units can be replaced prior to the earlier participated in and/or accepted offer units. In exemplary embodiments, participated in and/or accepted offer units can be replaced following a last in first out scheme.

In exemplary embodiments, amongst other things, to increase transparency the systems and methods provide information to any potential purchaser, for example, as illustrated in FIG. 2G, so that they can modify their participation request, for example, in light of other accepted offer units and/or can be made aware of configurations and/or modifications to offering. In exemplary embodiments, accepted offer units and/or configurations and/or modifications to offerings can be communicated and/or accessed by any of offer system 100, matching system 102, and/or potential purchaser system 104. For example, any potential purchaser affiliated potential purchaser system 104 and/or offeror affiliated with offer system 100 and/or matching system 102 can view a database of currently accepted offer units in one or more groups of offer units. This can be done to, for example, ascertain what the relevant market (e.g., accepted offer units, other participants, etc.) set as the value of the security and/or other items being offered. Further, this can be done to, for example, be made aware of and/or utilize modified offerings. Hence, participation requests might be modified over time in response to accepted offers made by others, for example, as illustrated in FIG. 2H, and/or re-configurations and/or modifications to offerings, for example, as illustrated in FIG. 2I.

In exemplary embodiments, the systems and methods can provide interactive collections of indications of demand and/or real-time feedback display of the aggregate demand for participants in the offering and/or potential purchasers, for example, through a private and/or public data network (e.g., the Internet). In exemplary embodiments, the systems and methods can provide a group(s) of offer units that can be used to ascertain the demand for, for example, an anticipated new security issuance and/or the sale of a multiplicity of like goods and/or service units using participation requested and/or accepted offer units.

In exemplary embodiments, the one or more groups of offer units (e.g., the bidstream) can be represented by a graphic depiction of accepted offer units (e.g., reservation rights bidblocks), for example, as illustrated in FIG. 2G, which can be organized horizontally, vertically, and/or non-linearly on a visual display such as a user interface, that may, at times, be called a demand display screen. Further, in exemplary embodiments, units (e.g., bidblocks) can be placed in the one or more groups of offer units (e.g., bidstream) such that they represent one or more offer units (e.g. bidstream units). By selection of a limit to the number of offer units (e.g., bidblocks) or units at a given offer unit parameters, for example, price and/or volume, a particular group of offer units (e.g., bidstream) can provide a visual appearance that may be used to aid potential purchasers in, for example, analyzing the emerging demand as the pre-market self-organizes.

In exemplary embodiments, the systems and methods can be implemented in a variety of embodiments, which might accommodate applicable securities laws and regulations of any given legal and/or regulatory marketplace and/or contractual jurisdiction for non-securities-based items (e.g., locally in a given jurisdiction and/or globally across jurisdictions). Further, the systems and methods can be implemented in numerous financial markets, exchanges, and contractual jurisdictions around the world that may contain their own particular set of relevant legal and regulatory requirements. Furthermore, the systems and methods can also be applied to price discovery and allocation of nonsecurities-based items and contracts for items that may be difficult to price and to allocate fairly and efficiently.

In exemplary embodiments, the systems and methods can be utilized for the price discovery and allocation processes of new issuances of both equity and debt including, but not limited to, commercial paper, corporate bonds, municipal bonds, international bonds, sovereign debt, notes, and/or any combination and/or further separation thereof, to name a few, as well as non-securities-based contract rights, products and items, services, and property rights, to name a few.

In exemplary embodiments, the can be used for determining optimal pricing (e.g., price discovery) and the fair allocation and/or participation requests (e.g., indications-of-interest, etc.) prior to the offer or offer for sale of the actual equity, debt, securitizations, referenced securities, related instruments, and/or other assets in the offering. This can be accomplished, by way of example, interactively with participants by establishing the nature of demand in the pre-market through feedback, thus enabling demand behavior to emerge as the pre-market self-organizes. The items being priced (e.g., particular securities, commodities, securitized assets, units of services, etc.), can be substantially identical and may be referenced as offer units and/or groups of offer units.

In exemplary embodiments, the systems and methods can be used for pricing discovery and/or allocation of non-securities-based items. For example, the systems and methods can be used to analyze, price, hedge, and/or allocate risk during the process of insurance underwriting. In another example, the systems and methods can be used to price and/or allocate a portfolio of property or assets (e.g., real estate) that may have been packaged and/or securitized. The systems and methods can also be used to price and allocate the securitization of one or more agreements for benefits and/or outputs of contracts and/or similar instruments (e.g. a revenue or income stream, royalties from intellectual property, etc.). The systems and methods can be used to price and/or allocate units of goods/services by, for example, building an order book. Furthermore, the systems and methods can also be used in instances where the supply may be varied by the Issuer or Seller, based on the emerging demand discovered by participant interaction (e.g., pricing and allocating a production run of semiconductor chips which can be expanded by increased production/overtime production).

By way of example, in securities applications, a participation request and/or reservation right may not be a legal and binding contractual obligation, nor may it be an investment contract. A participation request and/or reservation right request can represent an “indication-of-interest” and/or reservation based on potential investor/purchaser feedback of demand for volumes and prices of an anticipated offering of securities, related instruments, and/or other assets, goods, or services. The participation request and/or reservation right request can be a proxy for demand and/or can be used for the purposes of optimizing pricing and/or promoting fairness in allocation as a pre-market activity that may be, for example, a more efficient and equitable alternative to current manual book-building and/or order book building processes.

In exemplary embodiments, depending on relevant securities and contractual laws/regulations, participation request and/or reservation right request may be options, warrants, and/or similar conditional instruments. Where legal prohibitions and/or regulations do not restrict referenced securities, a more direct linkage might be offered between the participation request and/or reservation right request and the securities and/or other assets eventually being offered as they become offered or finally available for sale. In the case of non-securities based applications, if allowed under relevant contractual law, the participation request and/or reservation right request can be binding.

In exemplary embodiments, the systems and methods can be used to develop a fair, equitable, and transparent new issuance process for equity (e.g., stock), debt securities (e.g., bonds, notes, commercial paper, etc.) and/or for related and/or similar instruments and/or rights, but can also provide a properly priced and allocated base of investors for a stable after-market. In exemplary embodiments, using the systems and methods, first-day exchange arbitrage might be substantially mitigated and/or substantially removed and/or reducing secondary market volatility.

The systems and methods can be used to increase the availability and lower cost of equity, debt finance, or securitization. Using the systems and methods, a liquid and transparent secondary market may encourage investors to participate in the stock, debt, securitization markets, and may increase the availability of capital and/or lower investor's required returns. Further, using the systems and methods, improvements in the efficiency, transparency, competition, and/or open access of various equity, deb, and securitization t markets may encourage more issuers to achieve their goals, for example, through the efficient and/or appropriate use of debt instruments and/or to extend the access of debt markets to a whole new group of potential investors that may be on a substantially level playing field.

In exemplary embodiments, the systems and methods can be used in a number of nonsecurities-based applications, for example, where fair and equitable pricing and allocation may have been difficult to optimize, determine, and/or execute.

In exemplary embodiments, instructions, communicated and/or accessed by offer system 100, matching system 102, and/or potential purchaser system 104, can direct the respective graphical user interfaces to display, for example, participated and/or accepted offer units yields and/or reservation yields along a first axis and volume and/or quantity along a second axis; along a third axis an additional aspect of each participated and/or accepted offer units and/or reservation; a plurality of axes and/or the information displayed in at least one axis can change; a representation of a normalization that can include at least two participated and/or accepted offer units and/or reservation; a representation of previous offerings of similar units; a representation of participated and/or accepted offer units and/or reservation exceeding a predetermined size; a representation of a type of entity associated with each participated and/or accepted offer units and/or reservation; a representation that is one or more of the following: static; iterative; and/or a simulation; and/or any combination and/or further separation thereof, and/or any other information and/or representation.

In exemplary embodiments, display information sent to a graphical user interface of a first potential purchaser system 104 can be generated based at least in part on information relating to the first potential debt instrument purchaser; display information sent to a graphical user interface of a second potential purchaser system 104 can be generated based at least in part on information relating to the second potential debt instrument purchaser; display information sent to a graphical user interface of a third potential purchaser system 104 can be generated based at least in part on information relating to the third potential debt instrument purchaser; and/or display information sent to a graphical user interface of any potential purchaser system 104 can be generated based at least in part on information relating to that potential debt instrument purchaser.

In exemplary embodiments, instructions, communicated and/or accessed by offer system 100, matching system 102, and/or potential purchaser system 104, can direct the respective graphical user interface to display additional information with at least one modified reservation; can direct a respective graphical user interface to display a calculator; can direct the respective graphical user interface to display a representation of there being participated and/or accepted offer units and/or accepted reservations that exceed the number of available units; can direct the respective graphical user interfaces to display a representation of a spread in the yields associated with each participated and/or accepted offer units and/or reservation; can direct the respective graphical user interfaces to display a representation of changes in yields of the participated and/or accepted offer units and/or reservations over time; can direct a respective graphical user interface to display an identification of the potential purchaser of at least one of the first participated and/or accepted offer units and/or reservation the second participated and/or accepted offer units and/or reservation, and/or the third participated and/or accepted offer units and/or reservation; can direct a respective graphical user interface to display an identification of the potential purchaser of at least one of the first participated and/or accepted offer units and/or reservation, the second participated and/or accepted offer units and/or reservation, the third participated and/or accepted offer units and/or reservation, and the participated and/or accepted offer units and/or fourth reservation; can direct the respective graphical user interfaces to display a representation of a projected set of participated and/or accepted offer units and/or reservations; any combination and/or further separation thereof; and/or any other instructions.

In exemplary embodiments, representations in the respective graphical user interface can include a representation of the outcomes of game theory-based scenarios.

In exemplary embodiments, offer system 100, matching system 102, and/or potential purchaser system 104 can carry out at least one simulation for configuring and/or modifying offerings as well as aspects of offerings using participated and/or accepted offer units, related groups of offer units, variables associated with groups of offer units, pricing scales, premiums, discounts, and/or discounts based on aggregated accepted volume, any combination and/or further separation thereof, and/or can carry out any simulation.

In exemplary embodiments, various instructions, that can be communicated and/or accessed by offer system 100, matching system 102, and/or potential purchaser system 104, can be used for directing a respective graphical user interface, such as, but not limited to, directing a respective graphical user interface to display multiple displays for units having different characteristics; directing a respective graphical user interface to display split screens for units having different characteristics; directing a respective graphical user interface to display tabbed screens for units having different characteristics any combination and/or further separation thereof; and/or for any instructions that can be used to direct a respective graphical user interface.

In exemplary embodiments, the debt instruments, for example, when offered for later sale, can include corporate bonds, commercial paper, municipal bonds, international bonds, sovereign debt, sub-sovereign debt, public debt, securitization of assets, notes, convertible debt securities; any combination and/or further separation thereof, and/or any debt instrument

In exemplary embodiments, the one or more types of debt instruments can include debt instruments of a series, debt instruments having the same maturity, debt instruments having the same coupon rate, debt instruments available for reservation by a predetermined investor class; any combination and/or separation thereof, and/or any type of debt instrument.

In exemplary embodiments, the offering can be for contractual rights and/or the contractual rights can include a revenue streams from one or more contracts. In exemplary embodiments, the contractual rights can be, but is not limited to, for goods and/or the goods can be commodities; for services; used to hedge risk and/or can be used to hedge risk that can be insurance; can be to real property; used property; to intellectual property; any combination and/or further separation thereof; and/or any other contractual rights.

In exemplary embodiments, the contractual rights can be contractual rights of a series, contractual rights having the same maturity; contractual rights having the same price; contractual rights available for reservation, for example, by a predetermined potential contract rights purchaser class; any combination and/or further separation thereof; and/or any type of contractual right.

In exemplary embodiments, potential contract rights purchasers (e.g., potential purchasers) can include, but is not limited to, one or more institutional potential contract rights purchasers; one or more retail potential contract rights purchasers; any combination and/or further separation thereof; and any person and/or group.

In exemplary embodiments, a threshold price for one or more participation requests and/or requests for reservations can be set.

In exemplary embodiments, the number of units of a particular type of the equity instrument offering available at a particular price can be limited to fewer units than the total number of units of the equity instrument offering.

In exemplary embodiments, the equity instruments, when offered for later sale, can include, but is not limited to, secondary offering equity instruments, shelf-offering equity instruments, international equity instruments, convertible equity instruments; any combination and/or further separation thereof; and/or any equity instrument.

In exemplary embodiments, the one or more types of equity instruments can include, but is not limited to, options on equity instruments, warrants on equity instruments, a restricted set of equity instruments, overallotments of equity instruments, equity instruments available for one or more participation requests and/or reservation by, for example, a predetermined investor class and/or type; any combination and/or further separation thereof; and/or any type of equity instrument.

In exemplary embodiments, a predetermined investor class and/or type and/or a investor class and/or type can include, but is not limited to, institutional investors; one or more retail investors; any combination and/or further separation thereof; and/or any predetermined investor class and/or type and/or any investor class and/or type.

In exemplary embodiments, the equity instruments for a predetermined investor class and/or type can have a predetermined price; the number of units of equity instruments for the predetermined investor class and/or type can be fixed; the equity instruments for the predetermined investor class and/or type can have one or more prices calculated based on the prices of other reservations that may be outside the predetermined investor class; any combination and/or further separation thereof; and/or any equity instrument. In exemplary embodiments, the offering can be for contractual rights and/or the contractual rights can include a revenue streams from one or more contracts. In exemplary embodiments, the contractual rights can be, but is not limited to, for goods and/or the goods can be commodities; for services; can be used to hedge risk and/or can be used to hedge risk that can be insurance; can be to real property; can be used property; can be to intellectual property; any combination and/or further separation thereof; and/or any other contractual rights.

In exemplary embodiments, the contractual rights can be contractual rights of a series.

In exemplary embodiments, one or more types of contractual rights can include, but is not limited to, contractual rights having the same maturity; contractual rights having the same price; contractual rights available for reservation, for example, by a predetermined potential contract rights purchaser class; any combination and/or further separation thereof; and/or any type of contractual right.

In exemplary embodiments, potential contract rights purchasers (e.g., potential purchasers) can include, but is not limited to, one or more institutional potential contract rights purchasers; one or more retail potential contract rights purchasers; any combination and/or further separation thereof; and any person and/or group.

In exemplary embodiments, a threshold price for one or more participation requests and/or requests for reservations can be set.

In exemplary embodiments, the number of units of a particular type of the equity instrument offering available at a particular price can be limited to fewer units than the total number of units of the equity instrument offering.

In exemplary embodiments, the equity instruments, when offered for later sale, can include, but is not limited to, secondary offering equity instruments, shelf-offering equity instruments, international equity instruments, convertible equity instruments; any combination and/or further separation thereof and/or any equity instrument.

In exemplary embodiments, the one or more types of equity instruments can include, but is not limited to, options on equity instruments, warrants on equity instruments, a restricted set of equity instruments, overallotments of equity instruments, equity instruments available for one or more participation requests and/or reservation by, for example, a predetermined investor class and/or type; any combination and/or further separation thereof; and/or any type of equity instrument.

In exemplary embodiments, a predetermined investor class and/or type and/or a investor class and/or type can include, but is not limited to, institutional investors; one or more retail investors; any combination and/or further separation thereof; and/or any predetermined investor class and/or type and/or any investor class and/or type.

In exemplary embodiments, the equity instruments for a predetermined investor class and/or type can have a predetermined price; the number of units of equity instruments for the predetermined investor class and/or type can be fixed; the equity instruments for the predetermined investor class and/or type can have one or more prices calculated based on the prices of other reservations that may be outside the predetermined investor class; any combination and/or further separation thereof; and/or any equity instrument.

In exemplary embodiments, the offering can be for contractual rights and/or the contractual rights can include a revenue streams from one or more contracts. In exemplary embodiments, the contractual rights can be, but is not limited to, for goods and/or the goods can be commodities; for services; can be used to hedge risk and/or can be used to hedge risk that can be insurance; can be to real property; can be used property; can be to intellectual property; any combination and/or further separation thereof; and/or any other contractual rights.

In exemplary embodiments, the contractual rights can be contractual rights of a series.

In exemplary embodiments, one or more types of contractual rights can include, but is not limited to, contractual rights having the same maturity; contractual rights having the same price; contractual rights available for reservation, for example, by a predetermined potential contract rights purchaser class; any combination and/or further separation thereof; and/or any type of contractual right.

In exemplary embodiments, potential contract rights purchasers (e.g., potential purchasers) can include, but is not limited to, one or more institutional potential contract rights purchasers; one or more retail potential contract rights purchasers; any combination and/or further separation thereof; and any person and/or group.

In exemplary embodiments, a threshold price for one or more participation requests and/or requests for reservations can be set.

In exemplary embodiments, the number of units of a particular type of the equity instrument offering available at a particular price can be limited to fewer units than the total number of units of the equity instrument offering.

In exemplary embodiments, the equity instruments, when offered for later sale, can include, but is not limited to, secondary offering equity instruments, shelf-offering equity instruments, international equity instruments, convertible equity instruments; any combination and/or further separation thereof; and/or any equity instrument.

In exemplary embodiments, the one or more types of equity instruments can include, but is not limited to, options on equity instruments, warrants on equity instruments, a restricted set of equity instruments, overallotments of equity instruments, equity instruments available for one or more participation requests and/or reservation by, for example, a predetermined investor class and/or type; any combination and/or further separation thereof; and/or any type of equity instrument.

In exemplary embodiments, a predetermined investor class and/or type and/or a investor class and/or type can include, but is not limited to, institutional investors; one or more retail investors; any combination and/or further separation thereof; and/or any predetermined investor class and/or type and/or any investor class and/or type.

In exemplary embodiments, the equity instruments for a predetermined investor class and/or type can have a predetermined price; the number of units of equity instruments for the predetermined investor class and/or type can be fixed; the equity instruments for the predetermined investor class and/or type can have one or more prices calculated based on the prices of other reservations that may be outside the predetermined investor class; any combination and/or further separation thereof; and/or any equity instrument.

### Modifying Groups of Offer Units (e.g., Bidstreams)

Referring to FIGS. 3-11, in exemplary embodiments, offerings can be modified by, for example, adding one or more additional groups of offer units to the one or more groups of offer units; subtracting from the one or more groups of offer units by deleting one or more groups of offer units; splitting from the one or more groups of offer units at least one groups of offer units to form an additional one or more groups of offer units; reconfiguring one or more groups of offer units so that the number of offer units at the price point(s) within one or more groups of offer units can be adjusted; merging a first one or more groups of offer units with a second one or more groups of offer units; and/or any further combination and/or separation thereof, to name a few.

In exemplary embodiments, an offeror (e.g., issuer) may not anticipate demand for a given overall offering objective and/or offering. For example, demand may evolve as potential purchasers interact with one or more groups of offer units, interact with other potential purchasers, and/or interact across multiple groups of offering units. During building the participated in and/or accepted offer units within and/or among the one or more groups of offer units, the offeror may decide to add, split, reconfigure, or merge one or more groups of offer units to give potential purchasers more or fewer options and/or choices and/or to consolidate demand from multiple groups of offering units. For example, the offeror may decided to include new and/or reconfigured group(s) of offering units with different terms and/or characteristics.

In exemplary embodiments, different terms for one or more groups of offer units can include aspects of the offer units such as, but not limited to, maturity term of securities; related securities unit conditions such as, but not limited to, coupon rate, yield-to call, and/or conversion rights, to name a few; classifications of purchaser type such as, but not limited to institutional versus retail, wholesale versus retail, and/or pre-set premium group versus general publics, to name a few; condition of goods; delivery terms; any combination and/or further separation thereof; and/or any different term affiliated with aspects of the offer units. In exemplary embodiments, different characteristics of one or more groups of offer units can include aspects of one or more groups of offer units such as, but not limited to, shape and/or allocation grid dimensions such as, but not limited to number of offer units available at a given price point; thresholds for requests for registration; oversubscription buffers; any combination and/or further separation thereof, and/or any different term affiliated with aspects of one or more groups of offer units.

In exemplary embodiments, an offeror (e.g., issuer) can modify the overall offering structure by adding, splitting, merging group(s) of offer units of different terms or characteristics based on analysis. Further, in exemplary embodiments, an analysis module can be used to analyze parameters such as, but not limited to, of pricing momentum, pricing allocation, pricing range, pricing dispersion, allocation dispersion, types of investors (e.g., institutional v. retail), balance of indications of interest across multiple groups of offer units, spreads on multiple registration requests, behavior of potential purchasers in response to registration requests of others, iterative behavior of the same potential purchaser, and/or any combination and/or further separation thereof, to name a few.

### Adding/Subtracting Groups of Offer Units (e.g., Bidstreams) in Offering

Referring to FIG. 3A, in exemplary embodiments, offerings can be modified by adding one or more additional groups of offer units to the one or more groups of offer units and/or offerings can be modified by subtracting from the one or more groups of offer units by deleting one or more groups of offer units. By way of example, at step 302, using offer system 100 and/or matching system 102 an offering can be configured. The offering be configured to include one or more groups of offer units that can include one or more offer units and/or the offer units can be at one or more price points that can be available for one or more participation requests. Further, at step 304, one or more participation requests to participate in at least some of the one or more groups of offer units of the offering at the one or more price points can be received by offer system 100 and/or matching system 102 from potential purchaser system 104.

In exemplary embodiments, at step 306, one or more participation requests to participate in one or more groups of offer units of the offering can be accepted and/or rejected based on the availability of a one or more requested offer units and/or each of a one or more accepted offer units can be affiliated with one or more offer unit parameters. At step 308, messages can communicate to accepted potential purchasers and/or non-accepted potential purchasers the status of the one or more accepted offer units.

In exemplary embodiments, at step 310, using offer system 100 and/or matching system 102, an analysis can be performed within the one or more groups of offer units. In exemplary embodiments, the analysis can analyze groups of the one or more offer unit parameters, statistics related to groups of one or more offer unit parameters of the one or more accepted offer units, statistics related to groups of one or more offer unit parameters of a one or more non-accepted offer units, and/or any combination and/or further separation thereof, to name a few.

In exemplary embodiments, at step 312, it can be determined whether the offering may be modified, for example, in response to the analysis so that, at step 314, the one or more groups of offer units can be added to so an additional one or more groups of offer units may be added and/or subtracted from so the one or more groups of offer units can be deleted. Further, in exemplary embodiments, the modified offering can be re-offered, at step 316, to all potential purchasers.

In exemplary embodiments, in response to the analysis, at step 313, it may be determined that offering should not be modified and an analysis can be determined, at step 318, as to whether the offering is finished or not. If not finished, more participation request could be received, going back to step 304. If finished, at step 320, an order book may be generated.

Referring to FIG. 3B, in exemplary embodiments, offerings made available to potential purchasers can be modified by adding one or more additional groups of offer units to the one or more groups of offer units and/or offerings can be modified by subtracting from the one or more groups of offer units by deleting one or more groups of offer units. By way of example, at step 335, using offer system 100 and/or matching system 102 an offering can be configured and/or a configured offering can be transmitted to, received by, and/or viewed at potential purchaser system 104. The offering be configured to include one or more groups of offer units that can include one or more offer units and/or the offer units can be at one or more price points that can be available for one or more participation requests. Further, at step 334, one or more participation requests to participate in at least some of the one or more groups of offer units of the offering at the one or more price points can be transmitted to offer system 100 and/or matching system 102 from potential purchaser system 104.

In exemplary embodiments, at step 336, one or more participation requests, transmitted to offer system 100 and/or matching system 102 from potential purchaser system 104, to participate in one or more groups of offer units of the offering can be accepted and/or rejected based on the availability of a one or more requested offer units and/or each of a one or more accepted offer units can be affiliated with one or more offer unit parameters. At step 338, messages, received at potential purchaser system 104 from offer system 100 and/or matching system 102, can communicate to accepted potential purchasers and/or non-accepted potential purchasers the status of the one or more accepted offer units.

In exemplary embodiments, at step 340, using offer system 100 and/or matching system 102, an analysis can be performed within the one or more groups of offer units. In exemplary embodiments, the analysis can analyze groups of the one or more offer unit parameters, statistics related to groups of one or more offer unit parameters of the one or more accepted offer units, statistics related to groups of one or more offer unit parameters of a one or more non-accepted offer units, and/or any combination and/or further separation thereof, to name a few.

In exemplary embodiments, at step 342, it can be determined whether the offering may be modified, for example, in response to the analysis so that, at step 344, the one or more groups of offer units can be added to so an additional one or more groups of offer units may be added and/or subtracted from so the one or more groups of offer units can be deleted. Further, in exemplary embodiments, the modified offering can be re-offered, for example, a modified offering can be received at potential purchaser system 104 from offer system 100 and/or matching system 102, at step 346, to all potential purchasers.

In exemplary embodiments, in response to the analysis, at step 343, it may be determined that offering should not be modified and an analysis can be determined, at step 348, as to whether the offering is finished or not. If not finished, more participation request could be transmitted, for example, from potential purchaser system 104 from offer system 100 and/or matching system 102, going back to step 334. If finished, at step 350, an order book may be generated that can be transmitted to, received by, and/or viewed at potential purchaser system 104.

Referring to FIG. 4, in exemplary embodiments, in response to an analysis the one or more groups of offer units can be added to so an additional one or more groups of offer units may be generated. For example, in offering 400 one or more groups of offer units 402 can be participated in and/or accepted and offering 400 can be oversubscribed and/or utilize oversubscription buffer 410/412 for additional participated and/or accepted offer units. Further, analyzing groups of the one or more offer unit parameters, statistics related to groups of one or more offer unit parameters of the one or more accepted offer units, statistics related to groups of one or more offer unit parameters of a one or more non-accepted offer units, it may be determined that an additional one or more groups of offer units 404 should be generated for offering 400.

Referring to FIG. 5, in exemplary embodiments, in response to an analysis the one or more groups of offer units can be subtracted from so one or more groups of offer units can be deleted. For example, in offering 500 one or more groups of offer units 502 and one or more groups of offer units 504 can be fully subscribed, oversubscribed, and/or utilizing oversubscription buffer while another one or more groups of offer units 506 can be undersubscribed. Further, analyzing groups of the one or more offer unit parameters, statistics related to groups of one or more offer unit parameters of the one or more accepted offer units, statistics related to groups of one or more offer unit parameters of a one or more non-accepted offer units, it may be determined that an additional one or more groups of offer units 506 should be removed from offering 500.

In exemplary embodiments, debt offerings can be modified by adding one or more additional groups of offer units to the one or more groups of offer units and/or debt offerings can be modified by subtracting from the one or more groups of offer units by deleting one or more groups of offer units. In exemplary embodiments, the debt instruments in the debt offerings that can be modified, for example, when offered for later sale, can include corporate bonds, commercial paper, municipal bonds, international bonds, sovereign debt, sub-sovereign debt, public debt, securitization of assets, notes, convertible debt securities; any combination and/or further separation thereof, and/or any debt instrument.

In exemplary embodiments, the one or more types of debt instruments in the debt offerings that can be modified can include, but is not limited to, debt instruments of a series, debt instruments having the same maturity, debt instruments having the same coupon rate, debt instruments available for reservation by a predetermined investor class; any combination and/or separation thereof, and/or any type of debt instrument.

By way of example, an issuer (e.g., offeror), at and/or using offer system 100 and/or matching system 102, can configure a debt offering. Further, during the debt offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand for 5-yr. maturity bonds may be higher than expected. In order to extend the maturity for the entire offering and/or offer potential debt offering purchasers more purchasing options, another one or more group of offer units can be added that have a longer maturity. The system may then add a group of offer units with 7-yr. maturity bonds and/or modify debt offering re-offered. Communications, from offer system 100 and/or matching system 102, to accepted and/or non-accepted potential bond purchasers, at potential purchaser system 104, can be transmitting and can include information affiliated with the modified debt offering. The issuer can then accept and/or reject one or more participation requests, at and/or using offer system 100 and/or matching system 102, for both the existing 5-yr. maturity bond group of offer units and/or the added 7-yr. maturity bond group of offer units.

Following the above example, from the viewpoint of the potential debt offering purchasers, communications regarding the modified debt offering can be received, at potential purchaser system 104, that include information affiliated with the modification of the debt offering, the 5-yr maturity bond group of offer units, and/or the added 7-yr. maturity bond group of offer units. The potential debt offering purchasers can then make participation requests for the 5-yr. maturity bond offer group of offer units and/or the 7-yr. maturity bond group of offer units.

In exemplary embodiments, equity offerings can be modified by adding one or more additional groups of offer units to the one or more groups of offer units and/or equity offerings can be modified by subtracting from the one or more groups of offer units by deleting one or more groups of offer units. In exemplary embodiments, the equity instruments in the equity offerings that can be modified, for example, when offered for later sale, can include, but is not limited to, secondary offering equity instruments, shelf-offering equity instruments, international equity instruments, convertible equity instruments; any combination and/or further separation thereof; and/or any equity instrument.

In exemplary embodiments, the one or more types of equity instruments in the equity offerings that can be modified can include, but is not limited to, options on equity instruments, warrants on equity instruments, a restricted set of equity instruments, overallotments of equity instruments, equity instruments available for one or more participation requests and/or reservation by, for example, a predetermined investor class and/or type; any combination and/or further separation thereof and/or any type of equity instrument.

By way of example, an issuer (e.g., offeror), at and/or using offer system 100 and/or matching system 102, can configure a preferred equity shares offering. Further, during the equity offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand for preferred equity shares may be higher than expected. In order to take advantage of the excess demand and/or offer potential preferred equity offering purchasers more purchasing options, another one or more group of offer units can be added that have warrants for preferred equity shares. The system may then add a group of offer units with warrants for preferred equity shares and/or modify preferred equity shares offering re-offered. Communications, from offer system 100 and/or matching system 102, to accepted and/or non-accepted potential preferred equity shares purchasers, at potential purchaser system 104, can be transmitting and can include information affiliated with the modified preferred equity shares offering. The issuer can then accept and/or reject one or more participation requests, at and/or using offer system 100 and/or matching system 102, for both the existing preferred equity shares group of offer units and/or the added preferred equity shares warrants group of offer units.

Following the above example, from the viewpoint or the potential preferred equity shares offering purchasers, communications regarding the modified preferred equity shares offering can be received, at potential purchaser system 104, that include information affiliated with the modification of the preferred equity shares offering, the preferred equity shares group of offer units, and/or the added preferred equity shares warrants group of offer units. The potential preferred equity shares offering purchasers can then make participation requests for the preferred equity shares offer group of offer units and/or the preferred equity shares warrants group of offer units.

In exemplary embodiments, contractual right offerings can be modified by adding one or more additional groups of offer units to the one or more groups of offer units and/or contractual right offerings can be modified by subtracting from the one or more groups of offer units by deleting one or more groups of offer units. In exemplary embodiments, contractual right offerings that can be modified can be for con actual rights and/or the con actual rights can include a revenue streams from one or more contracts. The contractual rights can be, but is not limited to, for goods and/or the goods can be commodities; for services; for contracts used to hedge risk; for securitizations, for contracts used to hedge risk that can be insurance and/or re-insurance; to real property; used property; to intellectual property; any combination and/or further separation thereof; and/or any other contractual rights.

In exemplar embodiments, contractual right offerings that can be modified can include, but is not limited to, contractual rights of a series, contractual rights having the same maturity; contractual rights having the same price; contractual rights having different prices and/or terms; contractual rights available for reservation, for example, by a predetermined potential contract rights purchaser class; any combination and/or further separation thereof; and/or any type of contractual right.

By way of example, an issuer (e.g., offeror), at and/or using offer system 100 and/or matching system 102, can configure a re-insurance participation offering. Further, during the re-insurance participation offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand for re-insurance participation may be higher than expected. In order to take advantage of the excess demand and/or offer potential re-insurance participation offering purchasers more purchasing options, another one or more group of offer units can be added that have subordinated rights (e.g., during liability trigger events). The system may then add a group of offer units with subordinated rights during liability trigger events and/or modify re-insurance participation offering re-offered. Communications, from offer system 100 and/or matching system 102, to accepted and/or non-accepted potential re-insurance participation purchasers, at potential purchaser system 104, can be transmitting and can include information affiliated with the modified re-insurance participation offering. The issuer can then accept and/or reject one or more participation requests, at and/or using offer system 100 and/or matching system 102, for both the existing re-insurance participation group of offer units and/or the added re-insurance participation with subordinated rights group of offer units.

Following the above example, from the viewpoint of the potential re-insurance participation offering purchasers, communications regarding the modified re-insurance participation offering can be received, at potential purchaser system 104, that include information affiliated with the modification of the re-insurance participation offering, the re-insurance participation group of offer units, and/or the added re-insurance participation with subordinated rights group of offer units. The potential re-insurance participation offering purchasers can then make participation requests for the re-insurance participation offer group of offer units and/or the re-insurance participation with subordinated rights group of offer units.

### Splitting Groups of Offer Units (e.g., Bidstreams) in Offering

Referring to FIG. 6, in exemplary embodiments, offerings can be modified by splitting from the one or more groups of offer units at least one group of offer units to form an additional one or more groups of offer units. By way of example, at step 602, using offer system 100 and/or matching system 102 an offering can be configured. The offering be configured to include one or more groups of offer units that can include one or more offer units and/or the offer units can be at one or more price points that can be available for one or more participation requests. Further, at step 604, one or more participation requests to participate in at least some of the one or more groups of offer units of the offering at the one or more price points can be received by offer system 100 and/or matching system 102 from potential purchaser system 104.

In exemplary embodiments, at step 606, one or more participation requests to participate in one or more groups of offer units of the offering can be accepted and/or rejected based on the availability of a one or more requested offer units and/or each of a one or more accepted offer units can be affiliated with one or more offer unit parameters. At step 608, messages can communicate to accepted potential purchasers and/or non-accepted potential purchasers the status of the one or more accepted offer units.

In exemplary embodiments, at step 610, using offer system 100 and/or matching system 102, an analysis can be performed within the one or more groups of offer units. In exemplary embodiments, the analysis can analyze groups of the one or more offer unit parameters, statistics related to groups of one or more offer unit parameters of the one or more accepted offer units, statistics related to groups of one or more offer unit parameters of a one or more non-accepted offer units, and/or any combination and/or further separation thereof, to name a few.

In exemplary embodiments, at step 612, it can be determined whether the offering may be modified, for example, in response to the analysis so that, at step 614, the one or more groups of offer units can be split such that the one or more groups of offer units can form a one or more groups of offer units and an additional one or more groups of offer units. Further, in exemplary embodiments, the modified offering can be re-offered, at step 616, to all potential purchasers.

In exemplary embodiments, in response to the analysis, at step 613, it may be determined that offering should not be modified and an analysis can be determined, at step 618, as to whether the offering is finished or not. If not finished, more participation request could be received, going back to step 604. If finished, at step 620, an order book may be generated.

Referring to FIG. 7, in exemplary embodiments, offerings can be modified by splitting from the one or more groups of offer units at least one group of offer units to form an additional one or more groups of offer units. For example, in offering 700 one or more groups of offer units 702 can be participated in and/or accepted and offering 700 can be oversubscribed and/or utilize oversubscription buffer 710/712 for additional participated and/or accepted offer units. Further, analyzing groups of the one or more offer unit parameters, statistics related to groups of one or more offer unit parameters of the one or more accepted offer units, statistics related to groups of one or more offer unit parameters of a one or more non-accepted offer units, it may be determined that one or more groups of offer units 702 should be split to form one or more groups of offer units 704 and one or more groups of offer units 706 for offering 700.

In exemplary embodiments, debt offerings can be modified by splitting from the one or more groups of offer units at least one group of offer units to form an additional one or more groups of offer units. In exemplary embodiments, the debt instruments in the debt offerings that can be modified, for example, when offered for later sale, can include corporate bonds, commercial paper, municipal bonds, international bonds, sovereign debt, sub-sovereign debt, public debt, securitization of assets, notes, convertible debt securities; any combination and/or further separation thereof, and/or any debt instrument.

In exemplary embodiments, the one or more types of debt instruments in the debt offerings that can be modified can include, but is not limited to, debt instruments of a series, debt instruments having the same maturity, debt instruments having the same coupon rate, debt instruments available for reservation by a predetermined investor class; any combination and/or separation thereof, and/or any type of debt instrument.

By way of example, an issuer (e.g., offeror), at and/or using offer system 100 and/or matching system 102, can configure a debt offering. Further, during the debt offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand for 5-yr. maturity bonds may be oversubscribed by institutional potential purchasers and be short of the regulatory minimum participation by retail potential purchasers. In order to encourage participation by more retail potential purchasers to meet regulatory thresholds, the original group of offer units can be split (e.g., segmented) and restricted to institutional potential purchasers only and retail potential purchasers only. Following this example, a group of offer units restricted to retail potential purchasers only can be added, the previously accepted participation requests segmented into the institutional and retail only groups of offer units, and the modified debt offering re-offered. Communications, from offer system 100 and/or matching system 102, to accepted and/or non-accepted potential bond purchasers, at potential purchaser system 104, can be transmitting and can include information affiliated with the modified debt offering. The issuer can then accept and/or reject one or more participation requests, at and/or using offer system 100 and/or matching system 102, for both the institutional potential purchasers only 5-yr. bond group of offer units and/or the segmented retail potential purchasers only 5-yr. maturity bond group of offer units.

Following the above example, from the viewpoint of the potential debt offering purchasers, communications regarding the modified debt offering can be received, at potential purchaser system 104, that include information affiliated with the modification of the debt offering, the institutional potential purchasers only 5-yr maturity bond group of offer units, and/or the added retail potential purchasers only 5-yr. maturity bond group of offer units. The potential debt offering purchasers can then make participation requests for the institutional potential purchasers only 5-yr. maturity bond offer group of offer units or the retail potential purchasers only 5-yr. maturity bond group of offer units.

In exemplary embodiments, equity offerings can be modified by splitting from the one or more groups of offer units at least one group of offer units to form an additional one or more groups of offer units. In exemplary embodiments, the equity instruments in the equity offerings that can be modified, for example, when offered for later sale, can include, but is not limited to, secondary offering equity instruments, shelf-offering equity instruments, international equity instruments, convertible equity instruments; any combination and/or further separation thereof; and/or any equity instrument.

In exemplary embodiments, the one or more types of equity instruments in the equity offerings that can be modified can include, but is not limited to, options on equity instruments, warrants on equity instruments, a restricted set of equity instruments, overallotments of equity instruments equity instruments available for one or more participation requests and/or reservation by, for example, a predetermined investor class and/or type; any combination and/or further separation thereof; and/or any type of equity instrument.

By way of example, an issuer (e.g., offeror), at and/or using offer system 100 and/or matching system 102, can configure a common equity shares offering. Further, during the equity offering, the issuer can analyze, at and/or using offer system 100 and/or matching system 102, one or more groups of offer units to determine and/or identify, amongst other things, various modifications. For example, the offer system 100 and/or matching system 102 can determine and/or identify the retail demand for preferred equity shares may be higher than expected. In order to rebalance the common equity shares offering, attract more institutional potential purchaser support and/or offer potential common equity offering purchasers more purchasing options, another one or more group of offer units can be added that have volume discounts (with minimum offering unit lot sizes) for the desired, larger participation requests for common equity shares. The system may then added a group of offer units with volume discounts and participation request size minimums and/or modify common equity shares offering re-offered. Communications, from offer system 100 and/or matching system 102, to accepted and/or non-accepted potential common equity shares purchasers, at potential purchaser system 104, can be transmitting and can include information affiliated with the modified common equity shares offering. The issuer can then accept and/or reject one or more participation requests, at and/or using offer system 100 and/or matching system 102, for both the existing common equity shares group of offer units and/or the segmented common equity shares group of offer units with volume discounts and participation request size minimums.

Following the above example, from the viewpoint of the potential common equity shares offering purchasers, communications regarding the modified common equity shares offering can be received, at potential purchaser system 104, that include information affiliated with the modification of the common equity shares offering, the common equity shares group of offer units, and/or the added common equity shares with volume discounts and participation request size minimums group of offer units. The potential common equity shares offering purchasers can then make participation requests for the common equity shares offer group of offer units and/or the common equity shares with volume discounts and participation request size minimums group of offer units.

In exemplary embodiments, contractual right offerings can be modified by splitting from the one or more groups of offer units at least one group of offer units to form an additional one or more groups of offer units. In exemplary embodiments, contractual right offerings that can be modified can be for contractual rights and/or the contractual rights can include a revenue streams from one or more contracts The contractual rights can be, but is not limited to, for goods and/or the goods can be commodities; for services; for contracts used to hedge risk; for securitizations, for contracts used to hedge risk that can be insurance and/or re-insurance, to real property; used property; to intellectual property; any combination and/or further separation thereof; and/or any other contractual rights.

In exemplary embodiments, contractual right offerings that can be modified can include, but is not limited to, contractual rights of a series, contractual rights having the same maturity; contractual rights having the same price; contractual rights having different prices and/or terms; contractual rights available for reservation, for example, by a predetermined potential contract rights purchaser class; any combination and/or further separation thereof; and/or any type of contractual right.

By way of example, an issuer (e.g., offeror), at and/or using offer system 100 and/or matching system 102, can configure a commodity goods offering. Further, during the commodity goods offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand for the commodity goods may be higher than expected from wholesale potential purchasers who want a volume discount. In order to take maintain overall profit margins and/or offer potential commodity goods offering purchasers more purchasing options, another one or more group of offer units can be added that have volume discounts (at lower prices for larger offer unit size). The system may then add a group of offer units with volume discounts at lower prices and/or modify commodity goods offering re-offered. Communications, from offer system 100 and/or matching system 102, to accepted and/or non-accepted potential commodity goods purchasers, at potential purchaser system 104, can be transmitting and can include information affiliated with the modified commodity goods offering. The issuer can then accept and/or reject one or more participation requests, at and/or using offer system 100 and/or matching system 102, for both the existing commodity goods group of offer units and/or the added commodity goods with volume discounts at lower prices/larger offer unit size group of offer units.

Following the above example, from the viewpoint of the potential commodity goods offering purchasers, communications regarding the modified commodity goods offering can be received, at potential purchaser system 104, that include information affiliated with the modification of the commodity goods offering, the commodity goods group of offer units, and/or the added commodity goods with volume discounts at lower prices/larger offer unit size group of offer units. The potential commodity goods offering purchasers can then make participation requests for the commodity goods offer group of offer units and/or the commodity goods with volume discounts at lower prices/larger offer unit size group of offer units.

### Reconfiguring Groups of Offer Units (e.g., Bidstreams) in Offering

Referring to FIG. 8, in exemplary embodiments, offerings can be modified by reconfiguring one or more groups of offer units so that the number of offer units at the price point(s) within one or more groups of offer units can be adjusted. By way of example, at step 802, using offer system 100 and/or matching system 102 an offering can be configured. The offering be configured to include one or more groups of offer units that can include one or more offer units and/or the offer units can be at one or more price points that can be available for one or more participation requests. Further, at step 804, one or more participation requests to participate in at least some of the one or more groups of offer units of the offering at the one or more price points can be received by offer system 100 and/or matching system 102 from potential purchaser system 104.

In exemplary embodiments, at step 806, one or more participation requests to participate in one or more groups of offer units of the offering can be accepted and/or rejected based on the availability of a one or more requested offer units and/or each of a one or more accepted offer units can be affiliated with one or more offer unit parameters. At step 808, messages can communicate to accepted potential purchasers and/or non-accepted potential purchasers the status of the one or more accepted offer units.

In exemplary embodiments, at step 810, using offer system 100 and/or matching system 102, an analysis can be performed within the one or more groups of offer units. In exemplary embodiments, the analysis can analyze groups of the one or more offer unit parameters, statistics related to groups of one or more offer unit parameters of the one or more accepted offer units, statistics related to groups of one or more offer unit parameters of a one or more non-accepted offer units, and/or any combination and/or further separation thereof, to name a few.

In exemplary embodiments, at step 812, it can be determined whether the offering may be modified, for example, in response to the analysis so that, at step 814, the one or more groups of offer units can be reconfigured so that a number of the offer units at the one or more groups of offer units within the one or more groups of offer units may be adjusted. Further, in exemplary embodiments, the modified offering can be re-offered, at step 816, to all potential purchasers.

In exemplary embodiments, in response to the analysis, at step 813, it may be determined that offering should not be modified and an analysis can be determined, at step 818, as to whether the offering is finished or not. If not finished, more participation request could be received, going back to step 804. If finished, at step 820, an order book may be generated.

Referring to FIG. 9, in exemplary embodiments, offerings can be modified by reconfiguring one or more groups of offer units so that the number of offer units at the price point(s) within one or more groups of offer units can be adjusted. For example, in offering 900 one or more groups of offer units 902 can be participated in and/or accepted and offering 900 can be oversubscribed and/or utilize oversubscription buffer 910/912 for additional participated and/or accepted offer units. Further, analyzing groups of the one or more offer unit parameters, statistics related to groups of one or more offer unit parameters of the one or more accepted offer units, statistics related to groups of one or more offer unit parameters of a one or more non-accepted offer units, it may be determined that one or more groups of offer units 902 should be reconfiguring so that the number of offer units at the price point(s) within one or more groups of offer units 902 can be adjusted. For example, as shown, additional offer units 904 at price point(s) can be added within one or more groups of offer units 902. Further, the issuer may move existing accepted participation requests to a more advantageous price point and/or position within a price point in the reconfigured group of offer units.

In exemplary embodiments, debt offerings can be modified by reconfiguring one or more groups of offer units so that the number of offer units at the price point(s) within one or more groups of offer units can be adjusted. In exemplary embodiments, the debt instruments in the debt offerings that can be modified, for example, when offered for later sale, can include corporate bonds, commercial paper, municipal bonds, international bonds, sovereign debt, sub-sovereign debt, public debt, securitization of assets, notes, convertible debt securities; any combination and/or further separation thereof, and/or any debt instrument.

In exemplary embodiments, the one or more types of debt instruments in the debt offerings that can be modified can include, but is not limited to, debt instruments of a series, debt instruments having the same maturity, debt instruments having the same coupon rate, debt instruments available for reservation by a predetermined investor class; any combination and/or separation thereof, and/or any type of debt instrument.

By way of example, an issuer (e.g., offeror), at and/or using offer system 100 and/or matching system 102, can configure a debt offering. Further, during the debt offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand for 5-yr. maturity bonds may be higher than expected. In order to take advantage of the excess demand and reward potential debt offering purchaser who have already have accepted participation requests, the group of offer units can be reconfigured with additional offer unit at each price point (e.g. yield or yield equivalent). The system may then reconfigure a group of offer units with 5-yr. maturity bonds and/or modify debt offering re-offered. Further, the issuer may move existing accepted participation requests to a more advantageous price point and/or position within a price point within the 5-yr. maturity bond group of offer units. Communications, from offer system 100 and/or matching system 102, to accepted and/or non-accepted potential bond purchasers, at potential purchaser system 104, can be transmitting and can include information affiliated with the modified debt offering. The issuer can then accept and/or reject one or more participation requests, at and/or using offer system 100 and/or matching system 102, for the reconfigured 5-yr. maturity bond group of offer units.

Following the above example, from the viewpoint of the potential debt offering purchasers, communications regarding the modified debt offering can be received, at potential purchaser system 104, that include information affiliated with the modification of the debt offering, and/or the 5-yr maturity bond group of offer units. The potential debt offering purchasers can then make additional participation requests for the 5-yr. maturity bond group of offer units.

In exemplary embodiments, equity offerings can be modified by reconfiguring one or more groups of offer units so that the number of offer units at the price point(s) within one or more groups of offer units can be adjusted. In exemplary embodiments, the equity instruments in the equity offerings that can be modified, for example, when offered for later sale, can include, but is not limited to, secondary offering equity instruments, shelf-offering equity instruments, international equity instruments, convertible equity instruments; any combination and/or further separation thereof; and/or any equity instrument.

In exemplary embodiments, the one or more types of equity instruments in the equity offerings that can be modified can include, but is not limited to, options on equity instruments, warrants on equity instruments, a restricted set of equity instruments, overallotments of equity instruments, equity instruments available for one or more participation requests and/or reservation by, for example, a predetermined investor class and/or type; any combination and/or further separation thereof; and/or any type of equity instrument.

By way of example, an issuer (e.g., offeror), at and/or using offer system 100 and/or matching system 102, can configure an equity shares offering. Further, during the equity offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand for equity shares is oversubscribed. In order to take advantage of the excess demand, raise more capital, and/or offer more potential equity offering purchasers more purchasing options, the equity shares group of offer units can be reconfigured with more offer units at each price point. The system may then reconfigure an equity shares group of offer units and/or modify equity offering re-offered. Further, the issuer may move existing accepted participation requests to a more advantageous price point and/or position within a price point within the equity shares group of offer units. Communications, from offer system 100 and/or matching system 102, to accepted and/or non-accepted potential equity shares purchasers, at potential purchaser system 104, can be transmitting and can include information affiliated with the modified equity shares offering. The issuer can then accept and/or reject one or more participation requests, at and/or using offer system 100 and/or matching system 102, for the reconfigured equity shares group of offer units.

Following the above example, from the viewpoint of the potential equity shares offering purchasers, communications regarding the modified equity shares offering can be received, at potential purchaser system 104, that include information affiliated with the modification of the equity shares offering, and/or the equity shares group of offer units. The potential equity shares offering purchasers can then make participation requests for the reconfigured equity shares group of offer units.

In exemplary embodiments, contractual right offerings can be modified by reconfiguring one or more groups of offer units so that the number of offer units at the price point(s) within one or more groups of offer units can be adjusted. In exemplary embodiments, contractual right offerings that can be modified can be for contractual rights and/or the contractual rights can include a revenue streams from one or more contracts. The contractual rights can be, but is not limited to, for goods and/or the goods can be commodities; for services; for contracts used to hedge risk; for securitizations, for contracts used to hedge risk that can be insurance and/or re-insurance. to real property; used property; to intellectual property; any combination and/or further separation thereof; and/or any other contractual rights.

In exemplary embodiments, contractual right offerings that can be modified can include, but is not limited to, contractual rights of a series, contractual rights having the same maturity; contractual rights having the same price; contractual rights having different prices (and/or terms); contractual rights available for reservation, for example, by a predetermined potential contract rights purchaser class; any combination and/or further separation thereof; and/or any type of contractual right.

By way of example, an issuer (e.g., offeror), at and/or using offer system 100 and/or matching system 102, can configure a securitization offering. Further, during the securitization offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand for securitization may be higher than expected. In order to take advantage of the excess demand, raise more capital, and/or offer more potential equity offering purchasers more purchasing options, the securitization group of offer units can be reconfigured with more offer units at each price point. The system may then reconfigure a securitization group of offer units and/or modify securitization offering re-offered. Further, the issuer may move existing accepted participation requests to a more advantageous price point (and/or yield point or yield equivalent) and/or position within a price point within the securitization group of offer units. Communications, from offer system 100 and/or matching system 102, to accepted and/or non-accepted potential securitization purchasers, at potential purchaser system 104, can be transmitting and can include information affiliated with the modified securitization offering. The issuer can then accept and/or reject one or more participation requests, at and/or using offer system 100 and/or matching system 102, for the reconfigured securitization group of offer units.

Following the above example, from the viewpoint of the potential securitization offering purchasers, communications regarding the modified securitization offering can be received, at potential purchaser system 104, that include information affiliated with the modification of the securitization offering, and/or the securitization group of offer units. The potential securitization offering purchasers can then make participation requests for the reconfigured securitization group of offer units.

### Merging Groups of Offer Units (e.g., Bidstreams) in Offering

Referring to FIG. 10, in exemplary embodiments, offerings can be modified by merging a first one or more groups of offer units with a second one or more groups of offer units. By way of example, at step 1002, using offer system 100 and/or matching system 102 an offering can be configured. The offering be configured to include a first one or more groups of offer units and a second one or more groups of offer units that can both include one or more offer units and/or the offer units can be at one or more price points that can be available for one or more participation requests. Further, at step 1004, one or more participation requests to participate in at least some of the first one or more groups of offer units and the second one or more groups of offer units of the offering at the one or more price points can be received by offer system 100 and/or matching system 102 from potential purchaser system 104.

In exemplary embodiments, at step 1006, one or more participation requests to participate in the first one or more groups of offer units and the second one or more groups of offer units of the offering can be accepted and/or rejected based on the availability of a one or more requested offer units and/or each of a one or more accepted offer units can be affiliated with one or more offer unit parameters. At step 1008, messages can communicate to accepted potential purchasers and/or non-accepted potential purchasers the status of the one or more accepted offer units.

In exemplary embodiments, at step 1010, using offer system 100 and/or matching system 102, an analysis can be performed within the first one or more groups of offer units and the second one or more groups of offer units. In exemplary embodiments, the analysis can analyze groups of the one or more offer unit parameters, statistics related to groups of one or more offer unit parameters of the one or more accepted offer units, statistics related to groups of one or more offer unit parameters of a one or more non-accepted offer units, and/or any combination and/or further separation thereof, to name a few.

In exemplary embodiments, at step 1012, it can be determined whether the offering may be modified, for example, in response to the analysis so that, at step 1014, the first one or more groups of offer units and the second one or more groups of offer units can be merged. Further, in exemplary embodiments, the modified offering can be re-offered, at step 1016, to all potential purchasers.

In exemplary embodiments, in response to the analysis, at step 1013, it may be determined that offering should not be modified and an analysis can be determined, at step 1018, as to whether the offering is finished or not. If not finished, more participation request could be received, going back to step 1004. If finished, at step 1020, an order book may be generated.

Referring to FIG. 11, in exemplary embodiments, offerings can be modified by merging a first one or more groups of offer units with a second one or more groups of offer units. For example, in offering 1100 a first one or more groups of offer units 1102 and a second one or more groups of offer units 113 may not be oversubscribed and/or may not utilize oversubscription buffer for additional participated and/or accepted offer units. Further, analyzing groups of the one or more offer unit parameters, statistics related to groups of one or more offer unit parameters of the one or more accepted offer units, statistics related to groups of one or more offer unit parameters of a one or more non-accepted offer units, it may be determined that the first one or more groups of offer units 1102 and the second one or more groups of offer units 1103 can be merged into one or more groups of offer units 1102/1103.

In exemplary embodiments, debt offerings can be modified by merging a first one or more groups of offer units with a second one or more groups of offer units. In exemplary embodiments, the debt instruments in the debt offerings that can be modified, for example, when offered for later sale, can include corporate bonds, commercial paper, municipal bonds, international bonds, sovereign debt, sub-sovereign debt, public debt, securitization of assets, notes, convertible debt securities; any combination and/or further separation thereof, and/or any debt instrument.

In exemplary embodiments, the one or more types of debt instruments in the debt offerings that can be modified can include, but is not limited to, debt instruments of a series, debt instruments having the same maturity, debt instruments having the same coupon rate, debt instruments available for reservation by a predetermined investor class; any combination and/or separation thereof, and/or any type of debt instrument.

By way of example, an issuer (e.g., offeror), at and/or using offer system 100 and/or matching system 102, can configure a debt offering. Further, during the debt offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand by potential institutional purchasers is as expected, but that the demand by potential retail purchasers is may be lower than expected. In ensure the success of the entire offering and/or consolidate the purchasing demand, the two group of offer units can be merged into one group of offer units. The system may then merge the potential institutional purchasers group of offer units with the potential retail purchasers group of offer units and the modified debt offering re-offered. Communications, from offer system 100 and/or matching system 102, to accepted and/or non-accepted potential bond purchasers, at potential purchaser system 104, can be transmitting and can include information affiliated with the modified debt offering. The issuer can then accept and/or reject one or more participation requests, at and/or using offer system 100 and/or matching system 102, for the merged group of offer units.

Following the above example, from the viewpoint of the potential debt offering purchasers, communications regarding the modified debt offering can be received, at potential purchaser system 104, that include information affiliated with the modification of the debt offering, and/or the merged group of offer units. The potential debt offering purchasers can then make participation requests for the merged group of offer units.

In exemplary embodiments, equity offerings can be modified by merging a first one or more groups of offer units with a second one or more groups of offer units. In exemplary embodiments, the equity instruments in the equity offerings that can be modified, for example, when offered for later sale, can include, but is not limited to, secondary offering equity instruments, shelf-offering equity instruments, international equity instruments, convertible equity instruments; any combination and/or further separation thereof; and/or any equity instrument.

In exemplary embodiments, the one or more types of equity instruments in the equity offerings that can be modified can include, but is not limited to, options on equity instruments, warrants on equity instruments, a restricted set of equity instruments, overallotments of equity instruments, equity instruments available for one or more participation requests and/or reservation by, for example, a predetermined investor class and/or type; any combination and/or further separation thereof; and/or any type of equity instrument.

By way of example, an issuer (e.g., offeror), at and/or using offer system 100 and/or matching system 102, can configure an equity offering. Further, during the equity offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand by potential institutional purchasers is as expected, but that the demand by potential retail purchasers is may be lower than expected. In ensure the success of the entire offering and/or consolidate the purchasing demand, the two group of offer units can be merged into one group of offer units. The system may then merge the potential institutional purchasers group of offer units with the potential retail purchasers group of offer units and the modified equity offering re-offered. Communications, from offer system 100 and/or matching system 102, to accepted and/or non-accepted potential equity purchasers, at potential purchaser system 104, can be transmitting and can include information affiliated with the modified equity offering. The issuer can then accept and/or reject one or more participation requests, at and/or using offer system 100 and/or matching system 102, for the merged group of offer units.

Following the above example, from the viewpoint of the potential equity offering purchasers, communications regarding the modified equity offering can be received, at potential purchaser system 104, that include information affiliated with the modification of the equity offering, and/or the merged group of offer units. The potential equity offering purchasers can then make participation requests for the merged group of offer units.

In exemplary embodiments, contractual right offerings can be modified by merging a first one or more groups of offer units with a second one or more groups of offer units. In exemplary embodiments, contractual right offerings that can be modified can be for contractual rights and/or the contractual rights can include a revenue streams from one or more contracts. The contractual rights can be, but is not limited to, for goods and/or the goods can be commodities; for services; for contracts used to hedge risk; for securitizations, for contracts used to hedge risk that can be insurance and/or re-insurance. to real property; used property; to intellectual property; any combination and/or further separation thereof and/or any other contractual rights.

In exemplary embodiments, contractual right offerings that can be modified can include, but is not limited to, contractual rights of a series, contractual rights having the same maturity; contractual rights having the same price; contractual rights having different prices and/or terms; contractual rights available for reservation, for example, by a predetermined potential contract rights purchaser class; any combination and/or further separation thereof; and/or any type of contractual right.

By way of example, an issuer (e.g., offeror), at and/or using offer system 100 and/or matching system 102, can configure a property offering. Further, during the property offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand by potential wholesale purchasers is as expected, but that the demand by potential retail purchasers is may be lower than expected. In ensure the success of the entire property offering and/or consolidate the purchasing demand, the two group of offer units can be merged into one group of offer units. The system may then merge the potential wholesale purchasers group of offer units with the potential retail purchasers group of offer units and the modified property offering re-offered. Communications, from offer system 100 and/or matching system 102, to accepted and/or non-accepted potential property purchasers, at potential purchaser system 104, can be transmitting and can include information affiliated with the modified property offering. The issuer can then accept and/or reject one or more participation requests, at and/or using offer system 100 and/or matching system 102, for the merged group of offer units.

Following the above example, from the viewpoint of the potential property offering purchasers, communications regarding the modified property offering can be received, at potential purchaser system 104, that include information affiliated with the modification of the property offering, and/or the merged group of offer units. The potential property offering purchasers can then make participation requests for the merged group of offer units.

### Modifying Groups of Related Offer Units (e.g., Bidstreams)

Referring to FIGS. 12-15, In exemplary embodiments, related groups of offer units can be modified in offerings. For example, offerings can be modified in response to, for example, price point(s) of two or more groups of related offer units that may have changed; allocation within at least one of two or more groups of related offer units that may have changed; offer units within one group of offer units that may have been substituted for offer units within a second group of offer units; and/or any further combination and/or separation thereof, to name a few.

In exemplary embodiments, in scenarios with multiple groups of one or more groups of offer units, demand may be higher for one or more groups of offer units, for example, with different terms or characteristics, than another. The offeror (e.g., issuer) may desire to subtract and/or substitute offer units in one or more groups of offer units for another. In exemplary embodiments, the systems and methods can provide the offeror (e.g., issuer) with a module to analyze what to do and/or trade-offs. Further, in exemplary embodiments, the systems and methods can provide offeror (e.g., issuer) with a mechanism to automatically monitor and/or execute subtractions and/or substitutions between one or more groups of offer units.

In exemplary embodiments, offer units between one or more groups of offer units can be substituted based on analysis. Further, in exemplary embodiments, within the offering the balance of existing allocation matrices of one or more groups of related offer units can be shifted.

Referring to FIG. 12A, in exemplary embodiments, offerings can be modified because the offer units of the two or more groups of related offer units can be related to allow addition, subtraction, and/or substitution of each others offer units. By way of example, at step 1202, using offer system 100 and/or matching system 102 an offering can be configured. The offering be configured to include a two or more groups of related offer units that can both include one or more offer units and/or the offer units can be at one or more price points that can be available for one or more participation requests and/or the offer units of the two or more groups of related offer units can be related to allow addition, subtraction, and/or substitution of each others offer units. Further, at step 1204, one or more participation requests to participate in at least some of the two or more groups of related offer units of the offering at the one or more price points can be received by offer system 100 and/or matching system 102 from potential purchaser system 104.

In exemplary embodiments, at step 1206, one or more participation requests to participate in the two or more groups of related offer units of the offering can be accepted and/or rejected based on the availability of a one or more requested offer units and/or each of a one or more accepted offer units can be affiliated with one or more offer unit parameters. At step 1208, messages can communicate to accepted potential purchasers and/or non-accepted potential purchasers the status of the one or more accepted offer units.

In exemplary embodiments, at step 1212, using offer system 100 and/or matching system 102, an analysis can be performed within the two or more groups of related offer units. In exemplary embodiments, the analysis can analyze groups of the one or more offer unit parameters, statistics related to groups of one or more offer unit parameters of the one or more accepted offer units, statistics related to groups of one or more offer unit parameters of a one or more non-accepted offer units, and/or any combination and/or further separation thereof, to name a few.

In exemplary embodiments, at step 1212, it can be determined whether the offering may be modified, manually and/or automatically using a set of rules, for example, in response to the analysis so that, at step 1214, the one or more price points of the two or more groups of related offer units can be changed; allocation within at least one of the two or more groups of related offer units can be changed; the offer units within one of the two or more groups of related offer units can be substituted for the offer units within another of the two or more groups of related offer units; and/or any combination and/or further separation thereof, to name a few. Further, in exemplary embodiments, the modified offering can be re-offered, at step 1216, to all potential purchasers.

In exemplary embodiments, in response to the analysis, at step 1213, it may be determined that offering should not be modified and an analysis can be determined, at step 1218, as to whether the offering is finished or not. If not finished, more participation request could be received, going back to step 1204. If finished, at step 1220, an order book may be generated.

Referring to FIG. 12B, in exemplary embodiments, offerings made available to potential purchasers can be modified because the offer units of the two or more groups of related offer units can be related to allow addition, subtraction, and/or substitution of each others offer units.

By way of example, at step 1232, using offer system 100 and/or matching system 102 an offering can be configured and/or a configured offering can be transmitted to, received by, and/or viewed at potential purchaser system 104. The offering be configured to include a two or more groups of related offer units that can both include one or more offer units and/or the offer units can be at one or more price points that can be available for one or more participation requests and/or the offer units of the two or more groups of related offer units can be related to allow addition, subtraction, and/or substitution of each others offer units. Further, at step 1234, one or more participation requests to participate in at least some of the two or more groups of related offer units of the offering at the one or more price points can be transmitted to offer system 100 and/or matching system 102 from potential purchaser system 104.

In exemplary embodiments, at step 1236, one or more participation requests to participate in the two or more groups of related offer units of the offering can be accepted and/or rejected based on the availability of a one or more requested offer units and/or each of a one or more accepted offer units can be affiliated with one or more offer unit parameters. At step 1238, messages received, for example, at potential purchaser system 104, can communicate to accepted potential purchasers and/or non-accepted potential purchasers the status of the one or more accepted offer units.

In exemplary embodiments, at step 1242, an analysis can be performed within the two or more groups of related offer units. In exemplary embodiments, the analysis can analyze groups of the one or more offer unit parameters, statistics related to groups of one or more offer unit parameters of the one or more accepted offer units, statistics related to groups of one or more offer unit parameters of a one or more non-accepted offer units, and/or any combination and/or further separation thereof, to name a few.

In exemplary embodiments, at step 1242, it can be determined, for example, offer system 100 and/or matching system 102, whether the offering may be modified, manually and/or automatically using a set of rules, for example, in response to the analysis so that, at step 1244, the one or more price points of the two or more groups of related offer units can be changed; allocation within at least one of the two or more groups of related offer units can be changed; the offer units within one of the two or more groups of related offer units can be substituted for the offer units within another of the two or more groups of related offer units; and/or any combination and/or further separation thereof, to name a few. Further, in exemplary embodiments, the modified offering can be re-offered and received at potential purchaser system 104, at step 1246, for example, by all potential purchasers.

In exemplary embodiments, in response to the analysis, at step 1243, it may be determined that offering should not be modified and an analysis can determine at step 1248, as to whether the offering is finished or not. If not finished, more participation request could be transmitted, for example, potential purchaser system 104 to offer system 100 and/or matching system 102, going back to step 1234. If finished, at step 1250, an order book may be generated that can be transmitted to, received by, and/or viewed at potential purchaser system 104.

Referring to FIGS. 13-15, in exemplary embodiments, the one or more price points of the two or more groups of related offer units can be changed; allocation within at least one of the two or more groups of related offer units can be changed; the offer units within one of the two or more groups of related offer units can be substituted for the offer units within another of the two or more groups of related offer units.

Referring to FIG. 13, in exemplary embodiments, offering 1300 can include a first group of offer units 1302 and a second group of offer units 1303 that can be related to each other and/or can include different terms. Upon analysis of, for example, of groups of the one or more offer unit parameters, statistics related to groups of one or more offer unit parameters of the one or more accepted offer units, and/or statistics related to groups of one or more offer unit parameters of a one or more non-accepted offer units, it can be determined that the allocation of offer units in second group of offer units 1303 could be reconfigured and/or reduced and a number of offer units 1304, that may be equal to the number of offer units reconfigured and/or reduced in second group of offer units 1303, can be added to first group of offer units 1302. For example, first group of offer units 1302 can include five year bonds and second group of offer units 1303 can include seven year bonds. After running an analysis it can be determined that a greater demand exists for shorter maturities so the allocation of offer units for seven year bonds can be reconfigured and/or reduced to reflect balance with participation request and offer units 1304 can be added to first group of offer units 1302 thereby modifying offering 1300.

Referring to FIG. 14, in exemplary embodiments, offering 1400 can include a first group of offer units 1402 and a second group of offer units 1403 that can be related to each other and/or can include different cost unit scales. Upon analysis of, for example, of groups of the one or more offer unit parameters, statistics related to groups of one or more offer unit parameters of the one or more accepted offer units, and/or statistics related to groups of one or more offer unit parameters of a one or more non-accepted offer units, it can be determined that the allocation of offer units in second group of offer units 1403 could be reconfigured and/or reduced and a number of offer units 1404, that may be equal to the number of offer units reconfigured and/or reduced in second group of offer units 1403, can be added to first group of offer units 1402. For example, first group of offer units 1402 can include a first cost unit scale for contribution of money and second group of offer units 1403 can include a second cost unit scale for labor contributions. After running an analysis it can be determined that a greater demand exists for contribution of money than labor contribution so the allocation of offer units for labor contribution can be reconfigured and/or reduced to reflect balance with participation request and offer units 1404 can be added, for example, for contribution of money, to first group of offer units 1402 thereby modifying offering 1400.

Referring to FIG. 15, in exemplary embodiments, offering 1500 can include a first group of offer units 1502 and a second group of offer units 1503 that can be related to each other and/or can include different cost unit scales. Upon analysis of, for example, of groups of the one or more offer unit parameters, statistics related to groups of one or more offer unit parameters of the one or more accepted offer units, and/or statistics related to groups of one or more offer unit parameters of a one or more non-accepted offer units, it can be determined that the allocation of offer units in second group of offer units 1503 could be reconfigured and/or reduced and a number of offer units 1504, that may be equal to the number of offer units reconfigured and/or reduced in second group of offer units 1503, can be added to first group of offer units 1502. Further, in exemplary embodiments, accepted offer units in first group of offer units 1502 can be transferred to second group of offer units 1503. For example, first group of offer units 1502 can include a first cost unit scale for contribution of money and second group of offer units 1503 can include a second cost unit scale for labor contributions. After running an analysis it can be determined that a greater demand exists for contribution of money than labor contribution so the allocation of offer units for labor contribution can be reconfigured and/or reduced to reflect balance with participation request and offer units 1504 can be added, for example, for contribution of money, to first group of offer units 1502 thereby modifying offering 1500. Further, in exemplary embodiments, accepted offer units 1506 in first group of offer units 1502 for contributions of money can be transferred to second group of offer units, for example, such that the capital contributions can be utilized to contract with third-party additional labor units thereby creating more accepted offer units 1506 of labor contributions in second group of offer units 1503 and/or modifying offering 1500.

In exemplary embodiments, debt offerings can be modified because the offer units of the two or more groups of related offer units can be related to allow addition, subtraction, and/or substitution of each others offer units. In exemplary embodiments, the debt instruments in the debt offerings that can be modified, for example, when offered for later sale, can include corporate bonds, commercial paper, municipal bonds, international bonds, sovereign debt, sub-sovereign debt, public debt, securitization of assets, notes, convertible debt securities; any combination and/or further separation thereof, and/or any debt instrument.

In exemplary embodiments, the one or more types of debt instruments in the debt offerings that can be modified can include, but is not limited to, debt instruments of a series, debt instruments having the same maturity, debt instruments having the same coupon rate, debt instruments available for reservation by a predetermined investor class; any combination and/or separation thereof, and/or any type of debt instrument.

By way of example, an issuer (e.g., offeror), at and/or using offer system 100 and/or matching system 102, can configure a debt offering. Further, during the debt offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand for 5-yr. maturity bonds may be higher than expected and demand for 7-yr. maturity bonds is lower than expected (e.g., potential debt purchaser are preferring shorter maturities). In order to rebalance the debt offering with more of the preferred, shorter maturities, the groups of offer units can be reconfigured with additional offer units at each price point (e.g. yield or yield equivalent) added to the 5-yr. maturity bond group of offer units and fewer offer units at each price point (e.g. yield or yield equivalent) removed from the 7-yr. maturity bond group of offer units. The system may then reconfigure the groups of offer units with 5-yr. maturity bonds and 7-yr. maturity bonds and/or modify debt offering re-offered. Communications, from offer system 100 and/or matching system 102, to accepted and/or non-accepted potential bond purchasers, at potential purchaser system 104, can be transmitting and can include information affiliated with the modified debt offering. The issuer can then accept and/or reject one or more participation requests, at and/or using offer system 100 and/or matching system 102, for the reconfigured 5-yr. maturity bond group of offer units and/or the reconfigured 7-yr. maturity bond group of offer units.

Following the above example, from the viewpoint of the potential debt offering purchasers, communications regarding the modified debt offering can be received, at potential purchaser system 104, that include information affiliated with the modification of the debt offering, the 5-yr maturity bond group of offer units, and/or the 7-yr. maturity bond group of offer units. The potential debt offering purchasers can then make additional participation requests for the 5-yr. maturity bond group of offer units and/or the 7-yr. maturity bond group of offer units.

In exemplary embodiments, equity offerings can be modified because the offer units of the two or more groups of related offer units can be related to allow addition, subtraction, and/or substitution of each others offer units. In exemplary embodiments, the equity instruments in the equity offerings that can be modified, for example, when offered for later sale, can include, but is not limited to, secondary offering equity instruments, shelf-offering equity instruments, international equity instruments, convertible equity instruments; any combination and/or further separation thereof; and/or any equity instrument.

In exemplary embodiments, the one or more types of equity instruments in the equity offerings that can be modified can include, but is not limited to, options on equity instruments, warrants on equity instruments, a restricted set of equity instruments, overallotments of equity instruments, equity instruments available for one or more participation requests and/or reservation by, for example, a predetermined investor class and/or type; any combination and/or further separation thereof; and/or any type of equity instrument.

By way of example, an issuer (e.g., offeror), at and/or using offer system 100 and/or matching system 102, can configure an equity offering. Further, the issuer is accepting participation requests for both monetary resources (e.g., capital) and in-kind labor units. Further, in-kind labor units can be requested in the form of contributed labor (e.g., internal “sweat equity” and/or in-kind employee labor) and/or capital (from the first group of offer units) can be substituted for labor units in the second group of offer units by contracting from third-party labor providers. During the equity offering, the issuer can analyze, at and/or using offer system 100 and/or matching system 102, one or more groups of offer units to determine and/or identify, amongst other things, various modifications. For example, the offer system 100 and/or matching system 102 can determine and/or identify the potential equity purchasers prefer to provide more monetary resources than in-kind labor units. In order to rebalance the equity offering to reflect the imbalanced demand of capital providers to labor providers, the groups of offer units can be reconfigured with additional offer units at each price point added to the monetary group of offer units and fewer offer units at each price point removed from in-kind labor group of offer units. The system may then reconfigure the groups of offer units with monetary and in-kind labor offer units and/or equity offering re-offered. Further, the issuer may decide to shift offer units from the potential monetary purchaser group of offer units to the in-kind labor group of offer units by contracting with third-party labor providers to further balance the inequality of demand between potential monetary purchasers and potential in-kind labor providers (whether internal or third party providers). Communications, from offer system 100 and/or matching system 102, to accepted and/or non-accepted potential equity purchasers, at potential purchaser system 104, can be transmitting and can include information affiliated with the modified equity offering. The issuer can then accept and/or reject one or more participation requests, at and/or using offer system 100 and/or matching system 102, for the reconfigured monetary group of offer units and/or the reconfigured in-kind labor group of offer units.

Following the above example, from the viewpoint of the potential equity offering purchasers, communications regarding the modified equity offering can be received, at potential purchaser system 104, that include information affiliated with the modification of the equity offering, the monetary group of offer units, and/or the in-kind labor group of offer units. The potential equity offering purchasers can then make additional participation requests for the monetary group of offer units and/or the in-kind labor group of offer units.

In exemplary embodiments, contractual right offerings can be modified because the offer units of the two or more groups of related offer units can be related to allow addition, subtraction, and/or substitution of each others offer units. In exemplary embodiments, contractual right offerings that can be modified can be for contractual rights and/or the contractual rights can include a revenue streams from one or more contracts. The contractual rights can be, but is not limited to, for goods and/or the goods can be commodities; for services; for contracts used to hedge risk; for securitizations, for contracts used to hedge risk that can be insurance and/or re-insurance. to real property; used property; to intellectual property; any combination and/or further separation thereof; and/or any other contractual rights.

In exemplary embodiments, contractual right offerings that can be modified can include, but is not limited to, contractual rights of a series, contractual rights having the same maturity; contractual rights having the same price; contractual rights having different prices and/or terms; contractual rights available for reservation, for example, by a predetermined potential contract rights purchaser class; any combination and/or further separation thereof; and/or any type of contractual right.

By way of example, an issuer (e.g., offeror), at and/or using offer system 100 and/or matching system 102, can configure a services provision offering. Further, the issuer is accepting participation requests for both monetary resources (e.g., capital) and in-kind labor units. Further, in-kind labor units can be requested in the form of contributed labor and/or capital (from the first group of offer units) can be substituted for labor units in the second group of offer units by contracting from third-party labor providers. During the services provision offering, the issuer can analyze, at and/or using offer system 100 and/or matching system 102, one or more groups of offer units to determine and/or identify, amongst other things, various modifications. For example, the offer system 100 and/or matching system 102 can determine and/or identify the potential services provision purchasers prefer to provide more monetary resources than in-kind labor units. In order to rebalance the services provision offering to reflect the demand of capital providers to labor providers, the groups of offer units can be reconfigured with additional offer units at each price point added to the monetary group of offer units and fewer offer units at each price point removed from in-kind labor group of offer units. The system may then reconfigure the groups of offer units with monetary and in-kind labor offer units and/or modify services provision offering re-offered. Further, the issuer may decide to shift offer units from the potential monetary purchaser group of offer units to the in-kind labor group of offer units by contracting with third-party labor providers to further balance the inequality of demand between potential monetary purchasers and potential in-kind labor providers (whether internal or third party providers). Communications, from offer system 100 and/or matching system 102, to accepted and/or non-accepted potential services provision purchasers, at potential purchaser system 104, can be transmitting and can include information affiliated with the modified services provision offering. The issuer can then accept and/or reject one or more participation requests, at and/or using offer system 100 and/or matching system 102, for the reconfigured monetary group of offer units and/or the reconfigured in-kind labor group of offer units.

Following the above example, from the viewpoint of the potential services provision offering purchasers, communications regarding the modified services provision offering can be received, at potential purchaser system 104, that include information affiliated with the modification of the services provision offering, the monetary group of offer units, and/or the in-kind labor group of offer units. The potential services provision offering purchasers can then make additional participation requests for the monetary group of offer units and/or the in-kind labor group of offer units.

### Multidimensional Groups of Offer Units

In exemplary embodiments, offerings can be configured to include one or more groups of offer units that can include at least three variables and/or one or more groups of offer units can be multidimensional. For example, one or more groups of offer units can include offer units that include offer unit parameters, that can be price and volume, and one or more variables. Further, in exemplary embodiments, participation in one or more groups of offer units of an offering can be based on the availability of the requested offer units, each of the accepted offer units being affiliated with an offer unit parameters, and/or the one or more additional variables.

In exemplary embodiments, offer units (e.g., Bidstream units) can have other qualities, terms, and/or characteristics than, for example, price and/or volume that can affect the value and/or cost of the offering to an offeror (e.g., issuer). For example, in container shipping, there could also be a cost to the offeror based on weight of the contents of the container, for example, because weight may affect fuel used by the ship and/or the ability to take on more containers (e.g., offering units), for example, based on aggregate gross tonnage. Following this example, the offeror may not only be limited by volume (e.g., how many containers will fit on a ship), but the offer may also be limited by the allowable gross tonnage of the aggregate requested offering units. For another example, securities may have other features, for example, subordination and credit enhancement, that could add a third dimension and/or variable to the acceptance of participation requests and/or the value and/or cost to the offeror.

In exemplary embodiments, potential purchasers can communicate participation requests and/or bid on more than two axis and/or a multidimensional offering. For example, there can be a set offer volume (e.g., number of allocations), but potential purchasers can communicate participation requests and/or can bid on variables such as, but not limited to, price, one or more third factors (e.g., shipping weight), number of allocations, any combination and/or further separation thereof, and/or any variable affiliated with offerings, offer units, and/or groups of offerings.

Referring to FIG. 16, in exemplary embodiments, offerings can be configured to include one or more groups of offer units that can include at least three variables and/or one or more groups of offer units can be multidimensional. By way of example, at step 1602, using offer system 100 and/or matching system 102 an offering can be configured. The offering be configured to include a one or more groups of offer units that can include one or more offer units and/or the offer units can be at one or more price points and/or can include a one or more additional variables. The offering can be available for one or more participation requests. Further, at step 1604, one or more participation requests to participate in at least some of the one or more groups of offer units of the offering at the one or more price points and/or at the one or more additional variables can be received by offer system 100 and/or matching system 102 from potential purchaser system 104.

In exemplary embodiments, at step 1606, one or more participation requests to participate in the one or more groups of offer units of the offering can be accepted and/or rejected based on the availability of a one or more requested offer units and/or each of a one or more accepted offer units can be affiliated with a one or more offer unit parameters and/or the one or more additional variables. At step 1608, messages can communicate to accepted potential purchasers and/or non-accepted potential purchasers the status of the one or more accepted offer units.

In exemplary embodiments, offerings that may include at least three variables and/or one or more groups of offer units that may be multidimensional can be filled and/or subscribed to, for example, to generate a book. In exemplary embodiments, book generation for offerings that may include at least three variables and/or one or more groups of offer units that may be multidimensional can be accomplished using any of the techniques disclosed and/or utilizing any of the configuring and/or modifications disclosed.

Referring to FIG. 17, in exemplary embodiments, offerings can be configured to include one or more groups of offer units that can include at any number of variables and/or any number of dimensions (e.g., n dimension). For example, offering 1700 can include one or more groups of offer units 1702 which can include any number of variables such as, but not limited to, variable 1703, variable 1705, and/or variable 1707. By way of example, variable 1703 can be price, variable 1705 can be number of offer units, and/or variable 1707 can be an additional variable, for example, weight. Any method can be used to display the variables affiliated with one or more groups of offer units 1702. By way of example, a view can be rotated such that variable 1703 and variable 1705 can be displayed and/or variable 1705 and variable 1707 can be displayed.

In exemplary embodiments, one or more groups of offer units for any of number of variables can become filled and/or oversubscribed and participants offer unit positions can be modified and/or cancelled based on price and/or additional offer unit parameter considerations/limitations, for example, set by an offeror. In exemplary embodiments, modifications and/or cancelations can be independent of other axes or linked by algorithm(s), for example, analyzing total gross weight limitations of offer vs. ratio of trade-off between price and weight.

In exemplary embodiments, debt offerings can be configured and/or modified to include one or more groups of offer units that can include at least three variables and/or one or more groups of offer units can be multidimensional. In exemplary embodiments, the debt instruments in the debt offerings that can be configured and/or modified, for example, when offered for later sale, can include corporate bonds, commercial paper, municipal bonds, international bonds, sovereign debt, sub-sovereign debt, public debt, securitization of assets, notes, convertible debt securities; any combination and/or further separation thereof, and/or any debt instrument.

In exemplary embodiments, the one or more types of debt instruments in the debt offerings that can be configured and/or modified can include, but is not limited to, debt instruments of a series, debt instruments having the same maturity, debt instruments having the same coupon rate, debt instruments available for reservation by a predetermined investor class; any combination and/or separation thereof, and/or any type of debt instrument.

By way of example, an issuer (e.g., offeror), at and/or using offer system 100 and/or matching system 102, can configure a debt offering. Further, the issuer is accepting participation requests for offer units that have dimensions of both a (monetary) price and a limited number of credit enhancement units (e.g., there are more general debt offer units than units with credit enhancement and oversubscription will occur on credit enhancement requests before it occurs on price requests and/or there is a calculated trade-off between pricing of the offer units and the cost of credit enhancement). During the debt offering, the issuer can analyze, at and/or using offer system 100 and/or matching system 102, one or more groups of offer units to determine and/or identify, amongst other things, various modifications. For example, the offer system 100 and/or matching system 102 can determine and/or identify the credit enhancements being requested by the potential debt purchasers are rising faster than the prices requested. In order to rebalance the debt offering to manage the credit enhancement cost of the offer units requested, the groups of offer units can be reconfigured with additional offer units at each price point added to the price group of offer units and fewer offer units at each credit enhancement removed from credit enhancement group of offer units. Likewise, the oversubscription policies and the trade-off between price and credit enhancement can be re-calibrated and/or limitations to oversubscription can be reset (e.g. resetting allowable credit enhancement per offer unit, resetting allowable aggregate credit enhancement, etc.). The system may then reconfigure the groups of offer units with price and credit offer units and/or modify debt offering re-offered. Communications, from offer system 100 and/or matching system 102, to accepted and/or non-accepted potential debt purchasers, at potential purchaser system 104, can be transmitting and can include information affiliated with the modified debt offering. The issuer can then accept and/or reject one or more participation requests, at and/or using offer system 100 and/or matching system 102, for the reconfigured price group of offer units and/or the reconfigured credit enhancement group of offer units.

Following the above example, from the viewpoint of the potential debt offering purchasers, communications regarding the modified debt offering can be received, at potential purchaser system 104, that include information affiliated with the modification of the debt offering, the price group of offer units, and/or the credit enhancement group of offer units. The debt offering purchasers can then make additional participation requests for the price group of offer units and/or the credit enhancement group of offer units.

In exemplary embodiments, equity offerings can be configured and/or modified to include one or more groups of offer units that can include at least three variables and/or one or more groups of offer units can be multidimensional. In exemplary embodiments, the equity instruments in the equity offerings that can be configured and/or modified, for example, when offered for later sale, can include, but is not limited to, secondary offering equity instruments, shelf-offering equity instruments, international equity instruments, convertible equity instruments; any combination and/or further separation thereof; and/or any equity instrument.

In exemplary embodiments, the one or more types of equity instruments in the equity offerings that can be configured and/or modified can include, but is not limited to, options on equity instruments, warrants on equity instruments, a restricted set of equity instruments, overallotments of equity instruments, equity instruments available for one or more participation requests and/or reservation by, for example, a predetermined investor class and/or type; any combination and/or further separation thereof; and/or any type of equity instrument.

By way of example, an issuer (e.g., offeror), at and/or using offer system 100 and/or matching system 102, can configure an equity offering. Further, the issuer is accepting participation requests for offer units that have dimensions of both a (monetary) price and a limited number of matching warrants that can be request with each offer unit (e.g., there are more equity offer units than warrants and oversubscription will occur on warrants requests before it occurs on equity price requests and/or there is a calculated trade-off between pricing of the equity offer units and the cost of associated warrants). During the equity offering, the issuer can analyze, at and/or using offer system 100 and/or matching system 102, one or more groups of offer units to determine and/or identify, amongst other things, various modifications. For example, the offer system 100 and/or matching system 102 can determine and/or identify the warrants being requested by the potential equity purchasers are rising faster than the equity offer unit prices requested. In order to rebalance the equity offering to manage the warrants cost of the offer units requested, the groups of offer units can be reconfigured with additional offer units at each price point added to the equity price group of offer units and fewer offer units at each warrants level removed from the warrants group of offer units. Likewise, the oversubscription policies and the trade-off between equity offer unit price and warrants can be re-calibrated and/or limitations to oversubscription can be reset (e.g. resetting allowable warrants per offer unit, resetting allowable aggregate warrants, etc.). The system may then reconfigure the groups of offer units with price and warrant offer units and/or equity offering re-offered. Communications, from offer system 100 and/or matching system 102, to accepted and/or non-accepted potential equity purchasers, at potential purchaser system 104, can be transmitting and can include information affiliated with the modified equity offering. The issuer can then accept and/or reject one or more participation requests, at and/or using offer system 100 and/or matching system 102, for the reconfigured price group of offer units and/or the reconfigured warrants group of offer units.

Following the above example, from the viewpoint of the potential equity offering purchasers, communications regarding the modified equity offering can be received, at potential purchaser system 104, that include information affiliated with the modification of the equity offering, the price group of offer units, and/or the warrants group of offer units. The equity offering purchasers can then make additional participation requests for the equity price group of offer units and/or the warrants group of offer units.

In exemplary embodiments, contractual right offerings can be configured and/or modified to include one or more groups of offer units that can include at least three variables and/or one or more groups of offer units can be multidimensional. In exemplary embodiments, contractual right offerings that can be configured and/or modified can be for contractual rights and/or the contractual rights can include a revenue streams from one or more contracts. The contractual rights can be, but is not limited to, for goods and/or the goods can be commodities; for services; for contracts used to hedge risk; for securitizations, for contracts used to hedge risk that can be insurance and/or re-insurance. to real property; used property; to intellectual property; any combination and/or further separation thereof; and/or any other contractual rights.

In exemplary embodiments, contractual right offerings that can be configured and/or modified can include, but is not limited to, contractual rights of a series, contractual rights having the same maturity; contractual rights having the same price; contractual rights having different prices and/or terms; contractual rights available for reservation, for example, by a predetermined potential contract rights purchaser class; any combination and/or further separation thereof; and/or any type of contractual right.

By way of example, an issuer (e.g., offeror), at and/or using offer system 100 and/or matching system 102, can configure a container shipping services offering. Further, the issuer is accepting participation requests for offer units that have two components, both monetary price and weight units. During the container shipping services offering, the issuer can analyze, at and/or using offer system 100 and/or matching system 102, one or more groups of offer units to determine and/or identify, amongst other things, various modifications. For example, the offer system 100 and/or matching system 102 can determine and/or identify the weights being requested by the potential container services shipping purchasers are rising faster than the prices requested. In order to rebalance the container shipping services offering to reflect the imbalance of demand of weight per price per offer unit requested, the groups of offer units can be reconfigured with additional offer units at each price point added to the monetary group of offer units and fewer offer units at each weight removed from shipping weight group of offer units. Likewise, the oversubscription policies and the trade-off between price and weight can be re-calibrated and/or limitations to oversubscription can be reset (e.g. resetting allowable weight per container shipping offer unit, resetting allowable aggregate gross tonnage, etc.). The system may then reconfigure the groups of offer units with monetary and weight offer units and/or modify container shipping services offering re-offered. Communications, from offer system 100 and/or matching system 102, to accepted and/or non-accepted potential container shipping services purchasers, at potential purchaser system 104, can be transmitting and can include information affiliated with the modified container shipping services offering. The issuer can then accept and/or reject one or more participation requests, at and/or using offer system 100 and/or matching system 102, for the reconfigured monetary group of offer units and/or the reconfigured weight group of offer units.

Following the above example, from the viewpoint of the potential container shipping services offering purchasers, communications regarding the modified container shipping services offering can be received, at potential purchaser system 104, that include information affiliated with the modification of the container shipping services offering, the monetary group of offer units, and/or the weight group of offer units. The potential container shipping services offering purchasers can then make additional participation requests for the monetary group of offer units and/or the weight group of offer units.

### Variable Pricing Scale of Groups of Offer Units

In exemplary embodiments, offerings can be configured to include one or more groups of offer units that can include offer unit parameters, that can be price and volume, and an at least one variable pricing scale. Further, in exemplary embodiments, one or more pricing scales of offerings can be modified in response to analyzing within one or more groups of offer units the one or more groups of offer unit parameters, statistics related to the accepted groups of offer unit parameters, statistics related to non-accepted groups of offer unit parameters, and any combination and/or further separation thereof, to name a few. In exemplary embodiments, one or more pricing scales of offerings can be modified before and/or during an offering.

Referring to FIG. 18, in exemplary embodiments, offerings can be configured to include one or more groups of offer units that can include offer unit parameters, that can be price and volume, and a pricing scale. By way of example, at step 1802, using offer system 100 and/or matching system 102 an offering can be configured. The offering can be configured to include a one or more groups of offer units that can include one or more offer units and/or the offer units can be at one or more price points and/or can have an at least one variable pricing scale. The offering can be available for one or more participation requests. Further, at step 1804, one or more participation requests to participate in at least some of the one or more groups of offer units of the offering at the one or more price points can be received by offer system 100 and/or matching system 102 from potential purchaser system 104.

In exemplary embodiments, at step 1806, one or more participation requests to participate in the one or more groups of offer units of the offering can be accepted and/or rejected based on the availability of a one or more requested offer units and/or each of a one or more accepted offer units can be affiliated with a one or more offer unit parameters.

Referring to FIG. 19, in exemplary embodiments, one or more pricing scales of offerings can be modified in response to analyzing within one or more groups of offer units the one or more groups of offer unit parameters, statistics related to the accepted groups of offer unit parameters, statistics related to non-accepted groups of offer unit parameters, and any combination and/or further separation thereof, to name a few. By way of example, at step 1902, using offer system 100 and/or matching system 102 an offering can be configured. The offering be configured to include a one or more groups of offer units that can include one or more offer units and/or the offer units can be at one or more price points and/or can have an at least one variable pricing scale. The offering can be available for one or more participation requests. Further, at step 1904, one or more participation requests to participate in at least some of the one or more groups of offer units of the offering at the one or more price points can be received by offer system 100 and/or matching system 102 from potential purchaser system 104.

In exemplary embodiments, before an offering a analyzer and/or simulator module can be used for analyzing within one or more groups of offer units the one or more groups of offer unit parameters, statistics related to the accepted groups of offer unit parameters, statistics related to non-accepted groups of offer unit parameters, and any combination and/or further separation thereof, to name a few.

In exemplary embodiments, at step 1906, one or more participation requests to participate in the one or more groups of offer units of the offering can be accepted and/or rejected based on the availability of a one or more requested offer units and/or each of a one or more accepted offer units can be affiliated with a one or more offer unit parameters. At step 1908, messages can communicate to accepted potential purchasers and/or non-accepted potential purchasers the status of the one or more accepted offer units.

In exemplary embodiments, at step 1910, using offer system 100 and/or matching system 102, an analysis can be performed within the one or more groups of offer units. In exemplary embodiments, the analysis can analyze groups of the one or more offer unit parameters, statistics related to groups of one or more offer unit parameters of the one or more accepted offer units, statistics related to groups of one or more offer unit parameters of a one or more non-accepted offer units, and/or any combination and/or further separation thereof, to name a few.

In exemplary embodiments, at step 1912, it can be determined whether the offering may be modified, for example, in response to the analysis so that, at step 1914, the one or more groups of offer units can be added to so an additional one or more groups of offer units may be added and/or subtracted from so the one or more groups of offer units can be deleted. Further, at step 1912, in exemplary embodiments, it can be determined whether the one or more pricing scales of offerings may be modified in response to the analysis so that, at step 1914, the one ore more pricing scales can modified. Further, in exemplary embodiments, the modified offering can be re-offered, at step 1916, to all potential purchasers.

In exemplary embodiments, in response to the analysis, at step 1913, it may be determined that offering should not be modified and an analysis can be determined, at step 1918, as to whether the offering is finished or not. If not finished, more participation request could be received, going back to step 1904. If finished, at step 1920, an order book may be generated.

In exemplary embodiments, the offeror may not anticipate the evolution of demand for offer units and/or the effects that registration requests of one potential purchaser may have on other potential purchasers such as, but not limited to pricing momentum, pricing dispersion, and/or any effect. In exemplary embodiments, after an offering is fully subscribed and/or each of the offer units of a one or more groups of offerings is filled, fully participated in, and/or fully accepted, the offeror may have a different objective in the oversubscription mode.

Referring to FIGS. 20A-20B, in exemplary embodiments, offerings can be configured to include one or more groups of offer units that can include offer unit parameters, that can be price and volume, and a pricing scale and/or the one or more pricing scales of offerings can be modified.

In exemplary embodiments, configuring and/or modifying an offer, as shown in linear pricing scale 2002, an offeror can take into account consideration in building the market that factor in and/or extend beyond factoring in reaching full participation and/or pricing in a linear fashion. In exemplary embodiments, configuring and/or modifying an offer and/or using pricing scale 2004, the offeror can encourage substantially rapid participation of a number of potential purchasers to receive a mass of potential purchasers by keeping price point increases lower initially, for example, to draw participation into the offering, and then increase the growth in pricing scale, for example, to focus on substantially maximum price discovery once the offering has a mass of participation, for example, using a decelerating then accelerating variable pricing scale from a linear base. In exemplary embodiments, configuring and/or modifying an offer and/or using variable pricing scale 2006, the offeror may want to reach a critical offering funding to reach a threshold of offering funding by initially raising price points faster and/or then slowing the growth of price point increases, for example, to increase the purchasers base when the offeror may be comfortable that the minimum offer funding objectives was achieved, for example, using an accelerating then decelerating variable pricing scale from a linear base. In exemplary embodiments, configuring and/or modifying an offer using a variable pricing scale, the offeror can encourage and/or discourage early and/or later participation based on the buying strategy, price sensitivity, price elasticity, price/allotment objectives of the potential purchasers, any combination and/or further separation there of, to name a few.

In exemplary embodiments, after reaching full participation (e.g., all offer units in one or more groups of offer units are, for example, accepted offer units and/or participated in offer units) the one or more groups of offers units can go into oversubscription mode. In exemplary embodiments, the offer can then implement an extension continuation of the prior strategy, or change it.

In exemplary embodiments, after the initial objective of an offer is met, the offer can change objectives to, for example, maximizing total offering funding; maximizing total number of potential purchasers; and decreasing/increasing the spread between lowest and highest registered accepted price points in anticipation of closing the offering and final pricing and allocation, rewarding accepted offer units potential purchasers, for example, by slowing growth of price point increases, any combination and/or further separation thereof, to name a few.

In exemplary embodiments, the offer can be configured and/or modified to increase the rate of growth of scale of price points of oversubscription offer units focusing on price discovery under the oversubscription mode and then decrease the rate of growth of variable price points to settle the offering in anticipation of closing the offering and final pricing and allocation by, for example, using pricing scale 2008.

In exemplary embodiments, the offer can be configured and/or modified by the offeror to first slowly increase the rate of growth of scale of price points of oversubscription offer units, for example, to settle the majority of final allocations and then more rapidly increase the rate of growth of scale of price point of oversubscription units, for example, to maximize offer proceeds by pricing higher to potential offer unit purchasers who are insensitive to price (e.g., the potential may want to maintain an aggregate allocation regardless of price, the potential purchaser who may have had accepted offer units canceled by oversubscription and need to replace the lost acceptances regardless of price, etc.) using pricing scale 2010.

In exemplary embodiment, the offer can be configured and/or modified such that the initial price point scale strategy and/or the oversubscription price point scale strategy can be mixed and/or in combination.

In exemplary embodiments, configuring the offer, modifying the offer, decisions by the offer affiliated with configuring and/or modifying the offering can be supported before the offering by a simulation group of offer units configuration module and/or during the offering by an analysis and reconfiguration module.

In exemplary embodiments, reconfiguring and/or modifying the variable scale of the one or more groups of offer units can be made during the offer by being manually implemented by the offeror and/or being automatically implemented during the building of the accepted participation offer units of the offer using rules-based algorithm(s) that may be applied by the offeror and/or may be applied in reaction to the dynamics of the build of the accepted offer units within the one or more groups of offer units.

In exemplary embodiments, debt offerings can be configured and/or modified to include one or more groups of offer units that can include offer unit parameters, that can be price and volume, and an at least one variable pricing scale. In exemplary embodiments, the debt instruments in the debt offerings that can be configured and/or modified, for example, when offered for later sale, can include corporate bonds, commercial paper, municipal bonds, international bonds, sovereign debt, sub-sovereign debt, public debt, securitization of assets, notes, convertible debt securities; any combination and/or further separation thereof, and/or any debt instrument.

In exemplary embodiments, the one or more types of debt instruments in the debt offerings that can be configured and/or modified can include, but is not limited to, debt instruments of a series, debt instruments having the same maturity, debt instruments having the same coupon rate, debt instruments available for reservation by a predetermined investor class; any combination and/or separation thereof, and/or any type of debt instrument.

By way of example, an issuer (e.g., offeror), at and/or using offer system 100 and/or matching system 102, can configure a 5-yr. maturity municipal bond offering. Further, this municipal issuer desires a broad retail participation amongst the potential municipal bond offering purchasers. When configuring the initial price point (e.g., yield or yield equivalent) scale, the issuer uses a slowly ascending yield scale and then more rapidly accelerates the yield scale as the municipal bond offering has fuller participation. Further the issuer can run one or more simulations of potential municipal bond offering purchasers to refine his pricing (e.g., yield) scale strategy. Further, during the municipal bond offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand by ahead of schedule with high pricing momentum and good allocation dispersal across the yield scale. To tailor the oversubscription aspect of the offering to the analysis of these offering parameter statics, the issuer may choose to more rapidly accelerate the oversubscription yield early in the oversubscription and then slow the rate of yield scale as the offer nears completion to let the pricing momentum stabilize. The system may then adjust the oversubscription pricing scale and/or modify municipal bond offering re-offered. Communications, from offer system 100 and/or matching system 102, to accepted and/or non-accepted potential municipal bond purchasers, at potential purchaser system 104, can be transmitting and can include information affiliated with the modified municipal bond offering. The issuer can then accept and/or reject one or more participation requests, at and/or using offer system 100 and/or matching system 102, for group of offer units with the modified pricing (e.g., yield) scale.

Following the above example, from the viewpoint of the potential municipal bond offering purchasers, communications regarding the modified municipal bond offering can be received, at potential purchaser system 104, that include information affiliated with the pricing scale modification of the municipal bond offering, and/or the municipal bond group of offer units. The potential municipal bond offering purchasers can then make participation requests for the group of offer units with the modified pricing (e.g., yield) scale.

In exemplary embodiments, equity offerings can be configured and/or modified to include one or more groups of offer units that can include offer unit parameters, that can be price and volume, and an at least one variable pricing scale. In exemplary embodiments, the equity instruments in the equity offerings that can be configured and/or modified, for example, when offered for later sale, can include, but is not limited to, secondary offering equity instruments, shelf-offering equity instruments, international equity instruments, convertible equity instruments; any combination and/or further separation thereof; and/or any equity instrument.

In exemplary embodiments, the one or more types of equity instruments in the equity offerings that can be configured and/or modified can include, but is not limited to, options on equity instruments, warrants on equity instruments, a restricted set of equity instruments, overallotments of equity instruments, equity instruments available for one or more participation requests and/or reservation by, for example, a predetermined investor class and/or type; any combination and/or further separation thereof and/or any type of equity instrument.

By way of example, an issuer (e.g., offeror), at and/or using offer system 100 and/or matching system 102, can configure an equity offering. Further, this issuer desires to maximize pricing momentum and accelerate price discovery amongst the potential equity offering purchasers. When configuring the initial price point scale, the issuer uses a rapidly ascending price scale and then more slowly raises the price scale as the equity offering has fuller participation. Further the issuer can run one or more simulations of potential equity offering purchasers to refine his pricing scale strategy. Further, during the equity offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand is firm and the price discovery is reflective of the price momentum and good allocation dispersal across the price scale. To tailor the oversubscription aspect of the offering to the analysis of these offering parameter statics, the issuer may choose to more slowly raise the oversubscription price early in the oversubscription and then accelerate the rate of price scale as the offer nears completion to maximize the proceeds from the least price sensitive potential equity purchasers. The system may then adjust the oversubscription pricing scale and/or modify equity offering re-offered. Communications, from offer system 100 and/or matching system 102, to accepted and/or non-accepted potential equity purchasers, at potential purchaser system 104, can be transmitting and can include information affiliated with the modified equity offering. The issuer can then accept and/or reject one or more participation requests, at and/or using offer system 100 and/or matching system 102, for group of offer units with the modified pricing scale.

Following the above example, from the viewpoint of the potential equity offering purchasers, communications regarding the modified equity offering can be received, at potential purchaser system 104, that include information affiliated with the pricing scale modification of the equity offering, and/or the equity group of offer units. The potential equity offering purchasers can then make participation requests for the group of offer units with the modified pricing scale.

In exemplary embodiments, contractual right offerings can be configured and/or modified to include one or more groups of offer units that can include offer unit parameters, that can be price and volume, and an at least one variable pricing scale. In exemplary embodiments, contractual right offerings that can be configured and/or modified can be for contractual rights and/or the contractual rights can include a revenue streams from one or more contracts. The contractual rights can be, but is not limited to, for goods and/or the goods can be commodities; for services; for contracts used to hedge risk; for securitizations, for collo acts used to hedge risk that can be insurance and/or re-insurance. to real property; used property; to intellectual property; any combination and/or further separation thereof; and/or any other contractual rights.

In exemplary embodiments, contractual right offerings that can be configured and/or modified can include, but is not limited to, contractual rights of a series, contractual rights having the same maturity; contractual rights having the same price; contractual rights having different prices and/or terms; contractual rights available for reservation, for example, by a predetermined potential contract rights purchaser class; any combination and/or further separation thereof; and/or any type of contractual right.

By way of example, an issuer (e.g., offeror), at and/or using offer system 100 and/or matching system 102, can configure a semiconductor production run allocation offering. Further, this offeror wants to know that his sunk cost of running the facility are covered and also know whether there is enough demand to warrant planning overtime production runs. When configuring the initial price point scale, the issuer uses a slowly ascending price scale and then more rapidly accelerates the price scale as the semiconductor production run allocation offering has fuller participation. Further the offeror can run one or more simulations of potential semiconductor production run allocation offering purchasers to refine his pricing scale strategy. Further, during the semiconductor production run allocation offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand is solid for the standard production run allocation with but pricing momentum is slows at raising prices (e.g., price sensitivity). To tailor the oversubscription aspect of the offering to the analysis of these offering parameter statics, the offeror may choose to more rapidly accelerate the oversubscription yield early in the oversubscription and then slow the rate of pricing scale as the offer nears completion to let the pricing momentum stabilize. The system may then adjust the oversubscription pricing scale and/or modified semiconductor production run allocation offering re-offered. Communications, from offer system 100 and/or matching system 102, to accepted and/or non-accepted potential semiconductor production run allocation purchasers, at potential purchaser system 104, can be transmitting and can include information affiliated with the modified semiconductor production run allocation offering. The issuer can then accept and/or reject one or more participation requests, at and/or using offer system 100 and/or matching system 102, for group of offer units with the modified pricing scale.

Following the above example, from the viewpoint of the potential semiconductor production run allocation offering purchasers, communications regarding the modified semiconductor production run allocation offering can be received, at potential purchaser system 104, that include information affiliated with the pricing scale modification of the semiconductor production run allocation offering, and/or the semiconductor production run allocation group of offer units. The potential semiconductor production run allocation offering purchasers can then make participation requests for the group of offer units with the modified pricing scale.

### Discounting Offer Terms

In exemplary embodiments, offerings can be configured to include one or more groups of offer units that can include offer unit parameters, that can be price and volume, and a one or more conditional pricing options. Further, in exemplary embodiments, participation in one or more groups of offer units of an offering can be based on availability of the requested offer units, each of the accepted offer units being affiliated with an offer unit parameters and a one or more conditional pricing options parameters.

In exemplary embodiments, one or more groups of offer units can include characteristics other than price and/or volume that can affect the value and/or cost of the offering to an offeror. In exemplary embodiments, the offer can charge incremental costs and/or discounts to the potential purchaser from par [stated] purchaser-chosen price for accepting these options. For example, in securities, there can be binary options offered to the potential investor (e.g., subordination, credit enhancement, etc.) that can add to and/or subtract from their net offer unit price. For example, the offeror can operate alternative one or more groups of offer units with and without term options and decide which alternative one or more groups of offer units may be offered by the offeror.

In exemplary embodiments, the offeror can offer, test, and/or analyze the demand for and/or cost of offering conditional options on terms, for example, in addition to price and/or volume of potential offer units participation requests.

Referring to FIG. 21, in exemplary embodiments, offerings can be configured to include one or more groups of offer units that can include offer unit parameters, that can be price and volume, and a one or more conditional pricing options. By way of example, at step 2102, using offer system 100 and/or matching system 102 an offering can be configured. The offering be configured to include a one or more groups of offer units that can include one or more offer units and/or the offer units can be at one or more price points and/or can have a one or more conditional pricing options. The offering can be available for one or more participation requests. Further, at step 2104, one or more participation requests to participate in at least some of the one or more groups of offer units of the offering at the one or more price points and/or at the one or more conditional pricing options can be received by offer system 100 and/or matching system 102 from potential purchaser system 104.

In exemplary embodiments, at step 2106, one or more participation requests to participate in the one or more groups of offer units of the offering can be accepted and/or rejected based on the availability of a one or more requested offer units and/or each of a one or more accepted offer units can be affiliated with a one or more offer unit parameters and/or the one or more conditional pricing options. At step 2108, messages can communicate, from offer system 100 and/or matching system 102 to potential purchaser system 104, to accepted potential purchasers and/or non-accepted potential purchasers the status of the one or more accepted offer units.

In exemplary embodiments, at step 2110, using offer system 100 and/or matching system 102 an analysis can be performed within the one or more groups of offer units of groups of the one or more offer unit parameters and/or the one or more conditional pricing options. Further, in exemplary embodiments, at step 2112, using offer system 100 and/or matching system 102 the one or more conditional pricing options can be accepted and/or rejected.

In exemplary embodiments, at step 2116, acceptance of the one or more conditional pricing options, rejection of the one or more conditional pricing options, and/or an adjusted offer unit price of the one or more conditional pricing options accepted can be communicated from offer system 100 and/or matching system 102 to potential purchaser system 104. In exemplary embodiments, after being accepted, in at least some of the one or more groups of offer units of the offering using the one or more conditional pricing options a potential purchaser can participate and/or after rejection of the one or more conditional pricing options a potential purchaser can not participate.

Referring to FIG. 22, in exemplary embodiments, participant offer unit request can include one or more conditional pricing options and/or can be communicated to potential purchaser system 104, for example, from offer system 100 and/or matching system 102. Participant offer unit requests including one or more conditional pricing options 2202 can be presented in a form and/or in graphical user interface 103, 103′, and/or 103″ associated with potential purchaser system 104, offer system 100, and/or matching system 102. In exemplary embodiments, offerings and/or one or more participation requests 2202 can be configured and/or modified to include one or more groups of offer units that can include offer unit parameters, that can be price 2206 and volume 2208, and/or one or more conditional pricing options 2210. In exemplary embodiments, the price and/or cost affiliated with offerings and/or one or more participation requests 2202 can be adjusted based on one or more conditional pricing options 2210, for example, as shown in adjusted total 2212.

In exemplary embodiments, one or more participation requests 2202 can be communicated, potential purchaser system 104 to offer system 100, and/or matching system 102, by a potential purchaser selecting to submit 2214 one or more participation requests 2202.

In exemplary embodiments, debt offerings can be configured and/or modified to include one or more groups of offer units that can include offer unit parameters, that can be price and volume, and a one or more conditional pricing options. In exemplary embodiments, the debt instruments in the debt offerings that can be configured and/or modified, for example, when offered for later sale, can include corporate bonds, commercial paper, municipal bonds, international bonds, sovereign debt, sub-sovereign debt, public debt, securitization of assets, notes, convertible debt securities; any combination and/or further separation thereof, and/or any debt instrument.

In exemplary embodiments, the one or more types of debt instruments in the debt offerings that can be configured and/or modified can include, but is not limited to, debt instruments of a series, debt instruments having the same maturity, debt instruments having the same coupon rate, debt instruments available for reservation by a predetermined investor class; any combination and/or separation thereof, and/or any type of debt instrument.

By way of example, an issuer (e.g., offeror), at and/or using offer system 100 and/or matching system 102, can configure a 10-yr. maturity high-yield bond offering. Further, this issuer desires to know the demand for offering conditional pricing options (e.g., credit enhancement, subordination, warrant options, etc.). When configuring the initial, yield or yield equivalent price points, the issuer configures conditional pricing options adjustments to the yield requested by the potential high-yield bond offering purchasers. Further the issuer can run one or more simulations of potential high-yield bond offering purchasers to refine his conditional pricing options strategy. Further, during the high-yield bond offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand for requesting credit enhancement (e.g., at a premium adjustment) is high and demand for subordination (e.g., at a discount adjustment) is low. Following this example, the conditional pricing options may be adjusted and the credit enhancement option offered and the subordination option dropped and/or removed and the modified high-yield bond offering re-offered. Also, following this example, the conditional pricing options may be adjusted and the subordination option offered and the credit enhancement option dropped and/or removed and the modified high-yield bond offering re-offered. Communications, from offer system 100 and/or matching system 102, to accepted and/or non-accepted potential high-yield bond purchasers, at potential purchaser system 104, can be transmitting and can include information affiliated with the modified high-yield bond offering. The issuer can then accept and/or reject one or more participation requests, at and/or using offer system 100 and/or matching system 102, for group of offer units with the modified pricing options.

Following the above example, from the viewpoint of the potential high-yield bond offering purchasers, communications regarding the modified high-yield bond offering can be received, at potential purchaser system 104, that include information affiliated with the conditional pricing options modification of the high-yield bond offering, and/or the high-yield bond group of offer units. The potential high-yield bond offering purchasers can then make participation requests for the group of offer units with the modified pricing options.

In exemplary embodiments, equity offerings can be configured and/or modified to include one or more groups of offer units that can include offer unit parameters, that can be price and volume, and a one or more conditional pricing options. In exemplary embodiments, the equity instruments in the equity offerings that can be configured and/or modified, for example, when offered for later sale, can include, but is not limited to, secondary offering equity instruments, shelf-offering equity instruments, international equity instruments, convertible equity instruments; any combination and/or further separation thereof; and/or any equity instrument.

In exemplary embodiments, the one or more types of equity instruments in the equity offerings that can be configured and/or modified can include, but is not limited to, options on equity instruments, warrants on equity instruments, a restricted set of equity instruments, overallotments of equity instruments, equity instruments available for one or more participation requests and/or reservation by, for example, a predetermined investor class and/or type; any combination and/or further separation thereof; and/or any type of equity instrument.

By way of example, an issuer (e.g., offeror), at and/or using offer system 100 and/or matching system 102, can configure a preferred equity share offering. Further, this issuer desires to know the demand for offering conditional pricing options (e.g., credit enhancement for preferred share interest payments, pricing support, subordination rights to existing preferred equity shares, warrant options, etc.). When configuring the initial price point, the issuer configures conditional pricing options adjustments to the price requested by the potential preferred equity share offering purchasers. Further the issuer can run one or more simulations of potential preferred equity share offering purchasers to refine his conditional pricing options strategy. Further, during the preferred equity share offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand for requesting credit enhancement (at a premium adjustment) is low and demand for subordination (at a discount adjustment) is high. The system may then adjust the conditional pricing options and/or the subordination option offered and the credit enhancement option dropped and/or removed and the modified preferred equity share offering re-offered. Communications, from offer system 100 and/or matching system 102, to accepted and/or non-accepted potential preferred equity share purchasers, at potential purchaser system 104, can be transmitting and can include information affiliated with the modified preferred equity share offering. The issuer can then accept and/or reject one or more participation requests, at and/or using offer system 100 and/or matching system 102, for group of offer units with the modified pricing options.

Following the above example, from the viewpoint of the potential preferred equity share offering purchasers, communications regarding the modified preferred equity share offering can be received, at potential purchaser system 104, that include information affiliated with the conditional pricing options modification of the preferred equity share offering, and/or the preferred equity share group of offer units. The potential preferred equity share offering purchasers can then make participation requests for the group of offer units with the modified pricing options.

In exemplary embodiments, contractual right offerings can be configured and/or modified to include one or more groups of offer units that can include offer unit parameters, that can be price and volume, and a one or more conditional pricing options. In exemplary embodiments, contractual right offerings that can be configured and/or modified can be for contractual rights and/or the contractual rights can include a revenue streams from one or more contracts. The contractual rights can be, but is not limited to, for goods and/or the goods can be commodities; for services; for contracts used to hedge risk; for securitizations, for contracts used to hedge risk that can be insurance and/or re-insurance. to real property; used property; to intellectual property; any combination and/or further separation thereof and/or any other contractual rights.

In exemplary embodiments, contractual right offerings that can be configured and/or modified can include, but is not limited to, contractual rights of a series, contractual rights having the same maturity; contractual rights having the same price; contractual rights having different prices and/or terms; contractual rights available for reservation, for example, by a predetermined potential contract rights purchaser class; any combination and/or further separation thereof; and/or any type of contractual right.

By way of example, an issuer (e.g., offeror), at and/or using offer system 100 and/or matching system 102, can configure a revenue stream contract rights offering. Further, this issuer desires to know the demand for offering conditional pricing options (e.g., tiered and/or tranched preference rights to first revenues, currency hedges, delivery terms, etc.). When configuring the initial price point, the issuer configures conditional pricing options adjustments to the price requested by the potential revenue stream contract rights offering purchasers. Further the issuer can run one or more simulations of potential revenue stream contract rights offering purchasers to refine his conditional pricing options strategy. Further, during the revenue stream contract rights offering, the issuer can analyze, at and/or using offer system 100 and/or matching system 102, one or more groups of offer units to determine and/or identify, amongst other things, various modifications. For example, the offer system 100 and/or matching system 102 can determine and/or identify the demand for requesting tiered, preferred first revenue rights (at a premium adjustment) is low and demand for a currency hedge (at a discount adjustment) is high. The system may then adjust the conditional pricing options and/or the currency hedge option offered and the tiered, preferred first revenue rights option dropped and/or removed and the modified revenue stream contract rights offering re-offered. Communications, from offer system 100 and/or matching system 102, to accepted and/or non-accepted potential revenue stream contract rights purchasers, at potential purchaser system 104, can be transmitting and can include information affiliated with the modified revenue stream contract rights offering. The issuer can then accept and/or reject one or more participation requests, at and/or using offer system 100 and/or matching system 102, for group of offer units with the modified pricing options.

Following the above example, from the viewpoint of the revenue stream contract rights offering purchasers, communications regarding the modified revenue stream contract rights offering can be received, at potential purchaser system 104, that include information affiliated with the conditional pricing options modification of the revenue stream contract rights offering, and/or the revenue stream contract rights group of offer units. The potential revenue stream contract rights offering purchasers can then make participation requests for the group of offer units with the modified pricing options.

### Aggregate Volume Discount

In exemplary embodiments, offerings can be configured to include one or more groups of offer units that can include offer unit parameters, that can be price and volume, and an at least one aggregate volume discount. Further, in exemplary embodiments, participation in one or more groups of offer units of an offering can be based on availability of the requested offer units, each of the accepted offer units being affiliated with an offer unit parameters, and/or the at least one aggregate volume discount applied.

In exemplary embodiments, offerings can be configured, for example, by the offeror, to include offer volume discounts on one or more groups of offer units on multiple offer units and/or provide potential purchasers with an up-to-date account of their adjusted price(s) and aggregate price based on their current status in the one or more groups of offer units. Further, in exemplary embodiments, potential purchasers of one or more groups of offer units can be provided with module(s) and communications from the offeror with alerts and/or tools, for example, to manage their discount(s).

In exemplary embodiments, adjusted price from par [stated] accepted and/or participated in offer units prices can be based on the aggregate number of units across one or more groups of offer units. In exemplary embodiments, a module can be provided to potential offer unit purchasers, for example, to monitor and/or manage discounts.

Referring to FIG. 23, in exemplary embodiments, offerings can be configured to include one or more groups of offer units that can include offer unit parameters, that can be price and volume, and an at least one aggregate volume discount. By way of example, at step 2302, using offer system 100 and/or matching system 102 an offering can be configured. The offering be configured to include a one or more groups of offer units that can include one or more offer units and/or the offer units can be at one or more price points and/or can be at an at least one aggregate volume discount. In exemplary embodiments, at step 2304, a module for monitoring and/or analyzing the offer units at the one or more price points and/or the offer units at the one or more price points with the at least one aggregate volume discount applied can be communicated from offer system 100 and/or matching system 102 to potential purchaser system 104.

In exemplary embodiments, at step 2306, one or more participation requests to participate in at least some of the one or more groups of offer units of the offering at the one or more price points and/or at the at least one aggregate volume discount applied can be received by offer system 100 and/or matching system 102 from potential purchaser system 104.

In exemplary embodiments, at step 2306, one or more participation requests to participate in the one or more groups of offer units of the offering can be accepted and/or rejected based on the availability of a one or more requested offer units and/or each of a one or more accepted offer units can be affiliated with a one or more offer unit parameters and/or the one or more conditional pricing options. In exemplary embodiments, at step 2308, offer system 100 and/or matching system 102 can accept and/or reject the one or more participation requests in one or more groups of offer units of the offering based on, for example, the availability of a one or more requested offer units and/or each of a one or more accepted offer units can be affiliated with a one or more offer unit parameters and the at least one aggregate volume discount applied.

In exemplary embodiments, at step 2308, a communication of the offer units at the current one or more price points; the offer units at the current one or more price points with the current at least one aggregate volume discount applied; any changes to the offer units at the current one or more price points; any changes to the offer units at the current one or more price points with the current at least one aggregate volume discount applied; any combination and/or further separation thereof, to name a few can be communicated from offer system 100 and/or matching system 102 to potential purchaser system 104 and/or to the module.

Referring to FIG. 24, in exemplary embodiments, in exemplary embodiments, participant offer unit request can include aggregate volume discount and/or can be communicated to potential purchaser system 104, for example, from offer system 100 and/or matching system 102. Participant offer unit requests including an at least one aggregate volume discount 2402 can be presented in a form and/or in graphical user interface 103, 103′, and/or 103″associated with potential purchaser system 104, offer system 100, and/or matching system 102. In exemplary embodiments, offerings and/or one or more participation requests 2402 can be configured and/or modified to include one or more groups of offer units that can include offer unit parameters, that can be price 2206 and volume 2208, and/or one or more aggregate volume discount 2410. In exemplary embodiments, the price and/or cost affiliated with offerings and/or one or more participation requests 2402 can be adjusted based on at least one aggregate volume discount 2410, for example, as shown in adjusted total 2412.

In exemplary embodiments, one or more participation requests 2402 can be communicated, potential purchaser system 104 to offer system 100, and/or matching system 102, by a potential purchaser selecting to submit 2414 one or more participation requests 2402. In exemplary embodiments, a potential purchaser can select to analyze alternative discount scenarios 2416 and receive an analysis of various alternative discounts scenarios.

In exemplary embodiments, debt offerings can be configured and/or modified to include one or more groups of offer units that can include offer unit parameters, that can be price and volume, and an at least one aggregate volume discount. In exemplary embodiments, the debt instruments in the debt offerings that can be configured and/or modified, for example, when offered for later sale, can include corporate bonds, commercial paper, municipal bonds, international bonds, sovereign debt, sub-sovereign debt, public debt, securitization of assets, notes, convertible debt securities; any combination and/or further separation thereof, and/or any debt instrument.

In exemplary embodiments, the one or more types of debt instruments in the debt offerings that can be configured and/or modified can include, but is not limited to, debt instruments of a series, debt instruments having the same maturity, debt instruments having the same coupon rate, debt instruments available for reservation by a predetermined investor class; any combination and/or separation thereof, and/or any type of debt instrument.

By way of example, an issuer (e.g., offeror), at and/or using offer system 100 and/or matching system 102, can configure a short-term commercial paper debt offering. Further, this issuer wants to attract potential institutional purchasers. When configuring the initial price points (e.g., yield or yield equivalent), the issuer configures volume discount adjustments to the price (e.g., yield) requested by the potential short-term commercial paper debt offering purchasers. Further the issuer can run one or more simulations of potential short-term commercial paper debt offering purchasers to refine his volume discounting strategy. Further, during the short-term commercial paper debt offering, the issuer can analyze, at and/or using offer system 100 and/or matching system 102, one or more groups of offer units to determine and/or identify, amongst other things, various modifications. For example, the offer system 100 and/or matching system 102 can determine and/or identify a steeper discount is needed for high volume potential short-term commercial paper debt purchasers. The system may then adjust the volume discounts and/or modify short-term commercial paper debt offering re-offered. Communications, from offer system 100 and/or matching system 102, to accepted and/or non-accepted potential short-term commercial paper debt purchasers, at potential purchaser system 104, can be transmitting and can include information affiliated with the modified short-term commercial paper debt offering. The issuer can then accept and/or reject one or more participation requests, at and/or using offer system 100 and/or matching system 102, for group of offer units with the modified volume discounts.

Following the above example, from the viewpoint of the potential short-term commercial paper debt offering purchasers, communications regarding the modified short-term commercial paper debt offering can be received, at potential purchaser system 104, that include information affiliated with the volume discounts modification of the short-term commercial paper debt offering, and/or the short-term commercial paper debt group of offer units. Further, a module is supplied to potential short-term commercial paper debt purchasers that allows them to calculate discounts at different volumes, monitors accepted offer units and the affiliated aggregate discounts, alerts them to changes in discount status, runs discount analyses on alternative aggregate volumes, among others. The potential short-term commercial paper debt offering purchasers can then make participation requests for the group of offer units with the modified volume discounts.

In exemplary embodiments, equity offerings can be configured and/or modified to include one or more groups of offer units that can include offer unit parameters, that can be price and volume, and an at least one aggregate volume discount. In exemplary embodiments, the equity instruments in the equity offerings that can be configured and/or modified, for example, when offered for later sale, can include, but is not limited to, secondary offering equity instruments, shelf-offering equity instruments, international equity instruments, convertible equity instruments; any combination and/or further separation thereof; and/or any equity instrument.

In exemplary embodiments, the one or more types of equity instruments in the equity offerings that can be configured and/or modified can include, but is not limited to, options on equity instruments, warrants on equity instruments, a restricted set of equity instruments, overallotments of equity instruments, equity instruments available for one or more participation requests and/or reservation by, for example, a predetermined investor class and/or type; any combination and/or further separation thereof; and/or any type of equity instrument.

By way of example, an issuer (e.g., offeror), at and/or using offer system 100 and/or matching system 102, can configure an equity offering. Further, this issuer wants to attract potential institutional purchasers. When configuring the initial price points, the issuer configures volume discount adjustments to the price requested by the potential equity offering purchasers. Further the issuer can run one or more simulations of potential equity offering purchasers to refine his volume discounting strategy. Further, during the equity offering, the issuer can analyze, at and/or using offer system 100 and/or matching system 102, one or more groups of offer units to determine and/or identify, amongst other things, various modifications. For example, the offer system 100 and/or matching system 102 can determine and/or identify a steeper discount is needed for high volume potential equity purchasers. The system may then adjust the volume discounts and/or modify equity offering re-offered. Communications, from offer system 100 and/or matching system 102, to accepted and/or non-accepted potential equity purchasers, at potential purchaser system 104, can be transmitting and can include information affiliated with the modified equity offering. The issuer can then accept and/or reject one or more participation requests, at and/or using offer system 100 and/or matching system 102, for group of offer units with the modified volume discounts.

Following the above example, from the viewpoint of the potential equity offering purchasers, communications regarding the modified equity offering can be received, at potential purchaser system 104, that include information affiliated with the volume discounts modification of the equity offering, and/or the equity group of offer units. Further, a module is supplied to potential equity purchasers that allows them to calculate discounts at different volumes, monitors accepted offer units and the affiliated aggregate discounts, alerts them to changes in discount status, runs discount analyses on alternative aggregate volumes, among others. The potential equity offering purchasers can then make participation requests for the group of offer units with the modified volume discounts.

In exemplary embodiments, contractual right offerings can be configured and/or modified to include one or more groups of offer units that can include offer unit parameters, that can be price and volume, and an at least one aggregate volume discount. In exemplary embodiments, contractual right offerings that can be configured and/or modified can be for contractual rights and/or the contractual rights can include a revenue streams from one or more contracts. The contractual rights can be, but is not limited to, for goods and/or the goods can be commodities; for services; for contracts used to hedge risk; for securitizations, for contracts used to hedge risk that can be insurance and/or re-insurance. to real property; used property; to intellectual property; any combination and/or further separation thereof; and/or any other contractual rights.

In exemplary embodiments, contractual right offerings that can be configured and/or modified can include, but is not limited to, contractual rights of a series, contractual rights having the same maturity; contractual rights having the same price; contractual rights having different prices and/or terms; contractual rights available for reservation, for example, by a predetermined potential contract rights purchaser class; any combination and/or further separation thereof; and/or any type of contractual right.

By way of example, an issuer (e.g., offeror), at and/or using offer system 100 and/or matching system 102, can configure a manufactured goods offering. Further, this offeror wants to attract potential wholesale purchasers. When configuring the initial price points, the issuer configures volume discount adjustments to the price requested by the potential manufactured goods offering purchasers. Further the issuer can run one or more simulations of potential manufactured goods offering purchasers to refine his volume discounting strategy. Further, during the manufactured goods offering, the issuer can analyze, at and/or using offer system 100 and/or matching system 102, one or more groups of offer units to determine and/or identify, amongst other things, various modifications. For example, the offer system 100 and/or matching system 102 can determine and/or identify price momentum is twice as sensitive at lower volumes as higher volumes, The system may then adjust the volume discounts may and/or modify manufactured goods offering re-offered. Communications, from offer system 100 and/or matching system 102, to accepted and/or non-accepted potential manufactured goods purchasers, at potential purchaser system 104, can be transmitting and can include information affiliated with the modified manufactured goods offering. The issuer can then accept and/or reject one or more participation requests, at and/or using offer system 100 and/or matching system 102, for group of offer units with the modified volume discounts.

Following the above example, from the viewpoint of the potential manufactured goods offering purchasers, communications regarding the modified manufactured goods offering can be received, at potential purchaser system 104, that include information affiliated with the volume discounts modification of the manufactured goods offering, and/or the manufactured goods group of offer units. Further, a module is supplied to potential manufactured goods purchasers that allows them to calculate discounts at different volumes, monitors accepted offer units and the affiliated aggregate discounts, alerts them to changes in discount status, runs discount analyses on alternative aggregate volumes, among others. The potential manufactured goods offering purchasers can then make participation requests for the group of offer units with the modified volume discounts.

It will be understood that any of the steps described can be rearranged, separated, and/or combined without deviated from the scope of the invention. For ease, steps are, at times, presented sequentially. This is merely for ease and is in no way meant to be a limitation.

Further, it will be understood that any of the elements and/or exemplary embodiments of the invention described can be rearranged, separated, and/or combined without deviated from the scope of the invention. For ease, various elements are described, at times, separately. This is merely for ease and is in no way meant to be a limitation.

While the various steps, elements, and/or exemplary embodiments of the invention have been outlined above, it is evident that many alternatives, modifications and variations will be apparent to those skilled in the art. The various steps, elements, and/or exemplary embodiments of the invention, as set forth above, are intended to be illustrative, not limiting. Various changes may be made without departing from the spirit and scope of the invention. Accordingly, the spirit and scope of the present invention is to be construed broadly and limited only by the appended claims and not by the foregoing specification.

What is claimed is:

1. A method, comprising:
(1) configuring, using one or more computers, an equity offering, the equity offering comprising two or more groups of related offer units, comprising one or more offer units, the offer units being at one or more price points that are available for one or more participation requests, the offer units of the two or more groups of related offer units being related to allow at least one of addition, subtraction, or substitution of each other's offer units;
(2) receiving, at the one or more computers from a one or more potential purchaser computers, the one or more participation requests to participate in at least some of the two or more groups of related offer units of the equity offering at the one or more price points;
(3) determining, using the one or more computers, to at least one of accept or reject the one or more participation requests in the two or more groups of related offer units of the equity offering based on the availability of one or more requested offer units, each of one or more accepted offer units being affiliated with one or more offer unit parameters;
(4) communicating messages, from the one or more computers to a plurality of potential purchaser computers, of at least the one or more accepted offer units to accepted potential purchasers and non-accepted potential purchasers;
(5) analyzing, using the one or more computers, within the two or more groups of related offer units at least one of one or more groups of:
(i) the one or more offer unit parameters,
(ii) statistics related to groups of one or more offer unit parameters of the one or more accepted offer units, or
(iii) statistics related to groups of one or more offer unit parameters of one or more non-accepted offer units;
(6) modifying, using the one or more computers, at least one of manually or automatically using a set of rules, the equity offering in response to the analysis so that at least one of:
(i) the one or more price points of the two or more groups of related offer units is changed;
(ii) allocation within at least one of the two or more groups of related offer units is changed; or
(iii) the offer units within one of the two or more groups of related offer units are substituted for the offer units within another of the two or more groups of related offer units; and
(7) re-offering, from the one or more computers to the one or more potential purchaser computers, the modified equity offering to all potential purchasers.

2. The method of claim 1, further comprising:
communicating messages of the modification, after modifying the equity offering, to existing accepted potential purchasers and non-accepted potential purchasers.

3. The method of claim 1, wherein the equity offering generates an order book.

4. The method of claim 1, wherein the analysis is further comprising analysis of at least one of pricing momentum, pricing allocation, pricing range, pricing dispersion, allocation dispersion, types of purchaser, balance of the one or more participation requests accepted across multiple groups of the one or more groups of offer units, balance of the one or more participation requests not accepted across multiple groups of the one or more groups of offer units, spreads on multiple of the one or more participation requests accepted of the one or more groups of offer units, spreads on multiple of the one or more participation requests not accepted of the one or more groups of offer units, behavior of potential purchasers in response to the one or more participation requests accepted of other potential purchasers, or iterative behavior of the same potential purchaser.

5. The method of claim 1, wherein the one or more offer unit parameters is comprising price and volume.

6. The method of claim 1, further comprising: receiving, from the potential purchaser of the one or more accepted offer units, an accepting of the modified equity offering.

7. The method of claim 1, further comprising the step of not accepting a request for reservation that fails to meet a predetermined condition.
